(19) United States
(12) Patent Application Publication
(10) Pub. No.: US 2020/0065920 A1
(43) Pub. Date: Feb. 27, 2020

(54) CHARTER AIRLINE COMPUTERIZED RESERVATION SYSTEM WITH ONLINE COMMUNITIES TO SHARE RESERVATIONS

(71) Applicant: Jetappster, Inc., Fort Lauderdale, FL (US)

(72) Inventor: Barry Cohen, Fort Lauderdale, FL (US)

(21) Appl. No.: 16/535,584

(22) Filed: Aug. 8, 2019

Related U.S. Application Data
(60) Provisional application No. 62/720,442, filed on Aug. 21, 2018.

(51) Int. Cl. G06Q 50/14; G06Q 10/02; G06Q 30/02

(52) U.S. Cl. CPC G06Q 50/14; G06Q 30/0214; G06Q 10/02

(57) ABSTRACT

A charter reservation system which takes place on a server computer for creating charter airline reservations. User input is received for reserving one or more seats on a charter airline, in which the user is financially responsible for all the available seats on the charter airline. Thereafter, the user input is sent to a plurality of private charter airlines without the use on an intermediate broker. Once the user input is sent to the airlines, users are sent offers received from private charter airlines. The system receives user input regarding one of the offers received to reserve a customized charter shuttle with routes and times prescribed by the user input. If any available seats remain, the system receives user input to offer the seats to registered users on the charter reservation system. Thereafter, a credit is provided to the user for each available seat sold to other registered users.

### CROSS-REFERENCE TO RELATED APPLICATION

This application is a continuation application which claims the priority benefit of co-pending U.S. Provisional Patent Application Ser. No. 62/720,442, filed Aug. 21, 2018, for “Charter Airline Computerized Reservation System With Online Communities To Share Reservations,” the entire disclosure of which, including the drawings, is hereby incorporated by reference.

### PARTIAL WAIVER OF COPYRIGHT

All of the material in this patent application is subject to copyright protection under the copyright laws of the United States and of other countries. As of the first effective filing date of the present application, this material is protected as unpublished material. However, permission to copy this material is hereby granted to the extent that the copyright owner has no objection to the facsimile reproduction by anyone of the patent documentation or patent disclosure, as it appears in the United States Patent and Trademark Office patent file or records, but otherwise reserves all copyright rights whatsoever.

### TECHNICAL FIELD

This invention relates generally to computerized reservation systems. Specifically, it relates to methods and systems and computer program products for reserving seats on private jets without brokers.

### BACKGROUND OF THE INVENTION

Airline chartering services continue to grow. They offer booking services to a wide array of customers, including business and leisure travelers, sports teams, and corporations worldwide.

Prices and service vary tremendously in chartering services. Many customers make use of brokers that offer various incentives. Some incentives include “free” empty-leg positioning flights to its members who pay an initiation and annual charge. It means flying only where and when there is an open plane and there are strings.

Many times, users want to be in a specific place and you want to get to a specific place at a specific time. There is still a big variation beyond the gimmicks and promos that seem to proliferate charter marketing these days.

Therefore, in view of the state of the art, it may be advantageous to provide a computerized charter airline reservation system and method for using same that allows reservations to be shared. As in so many areas of airline charter technology, there is always room for improvement related to optimizing a computerized reservation system.

### SUMMARY OF THE INVENTION

The present invention revolutionizes the field of computerized reservations systems with online communities to share reservations.

The present invention provides a computer-implemented method which takes place on a server computer for creating charter airline reservations. The process starts and accesses a storage media commutatively coupled to a server computer as part of a charter reservation system. User input is received including a minimum number of seats, destination, and date range for reserving one or more seats on a charter airline for a specified route and time, in which the user is financially responsible for all the available seats on the charter airline. Thereafter, the user input is sent to a plurality of private charter airlines without the use on an intermediate broker.

Once the user input is sent to the airlines, users are sent offers received from private charter airlines. The system receives user input regarding one of the offers received to reserve a customized charter shuttle with routes and times prescribed by the user input (“Astro Charter”), in which this customized charter shuttle does not regularly offer these routes and times.

If there are any available seats left on the reserve shuttle, the system receives user input to offer the available seats to a group of registered users on the charter reservation system. Then, notices are sent to other registered users on the charter system based on the order of social connections. A determination is made as to whether there are still unsold seats after a predetermined period of time expires. If seats remain, the order of social connections is increased and the system repeats. If no seats remain, a credit is provided to the user for each available seat sold to other registered users on the customized charter.

The above advantages, in addition to other advantages and features, will be readily apparent from the following detailed description of the invention when taken in connection with the accompanying drawings.

### BRIEF DESCRIPTION OF THE DRAWINGS

For a more complete understanding of this disclosed inventive concept, reference should now be made to the embodiments illustrated in greater detail in the accompanying drawings and described below by way of examples of the disclosed inventive concept wherein:

FIGS. 1-6 are screen shots of the intro embodiment of the present invention;

FIGS. 7-26 are screen shots of the profile embodiment of the present invention;

FIGS. 27-40 are screen shots of the charter embodiment of the present invention;

FIGS. 41-42 are screen shots of the email embodiment of the present invention;

FIGS. 43-56 are screen shots of the deals embodiment of the present invention;

FIGS. 57-58 are screen shots of the shuttle embodiment of the present invention;

FIG. 59 is flow diagram of the major embodiments shown in FIGS. 1-58 for the client device;

FIG. 60 is a site map of the server-side flow for FIGS. 1-59;

FIG. 61 a social network displayed with a user's first, second, third, and fourth order connections highlighted;

FIG. 62 is the n-tier architecture upon which flow diagrams of FIGS. 59-60 can operate;

FIG. 63 is an example hardware implementation of the client and/or cloud computer upon which flow diagrams of FIGS. 59-60 can operate; and

FIG. 64 for a private social network using FIGS. 62-63.

### DETAILED DESCRIPTION OF THE INVENTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The present invention provides chartered air travel which is comfortable, flexible, and hassle-free. The present invention in one example is a revolutionary air charter service booking system that allows a user to connect directly to the jet operators, providing the user with more options with the best prices on the market. With fast online quotes directly from the operators, the user can book a private jet without a broker.

### Non-Limiting Definitions:

The terms “a,” “an,” and “the” preceding an element or component are intended to include the plural forms as well, unless the context clearly indicates otherwise.

“Broker” is an individual or company that has been given economic authority to sell seats on private jets.

“Charter Airline” is the business of renting at least a portion of an aircraft, typically the entire aircraft, i.e., chartering as opposed to individual aircraft seats by purchasing a ticket through a traditional airline. While the airlines specialize in selling transportation by the seat, charter airline companies focus on individual private aircrafts and itineraries, urgent or time-sensitive cargo, air ambulance service, and other forms of ad hoc air transportation. Charter jet categories include turbo props, light jets, mid-size jets, super mid-size jets, heavy jets, long-range jets, and VIP airliners.

“Create Your Own Shuttle” or “Astro Shuttle” is where an originating member takes financial responsibility for all the seats on an aircraft. Unlike a “Shuttle Charter” in which the route and times may be set, the “Create Your Own Shuttle” allows the originating member to select a customized route and a desired time. There may be a minimum number of seats that need to be purchased. Once the minimum number of seats is purchased by the originating member, the “Astro Shuttle” can become a “Shuttle Charter” by selection of a conversion button in the application employing the present invention by the originating member. In the “Shuttle Charter” the remaining seats go up for sale to other members. With each seat sold to other members, the financial risk to the originating member is decreased. The originating member receives flight credits for originating the flight, takes the financial responsibility of creating a Shuttle Charter, and sells excess seats.

“Geofencing” is the use of GPS or RFID technology to create a virtual geographic boundary, enabling software employing the present invention to trigger a response when a mobile device enters or leaves a particular area.

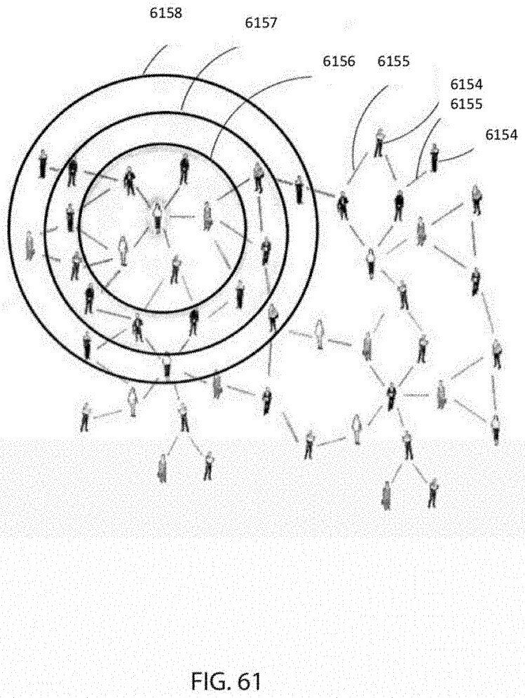

“Orders of Connection” is a chain in which users are associated with one another. This is shown in FIG. 61 illustrating first order, second order, and third order connections. A first order is typically immediate family members and friends. A second order is a user directly connected to one of the family members or friends. A third order is typically a user directly connected to one of the second order users.

“Private Charter” is where an entire aircraft, as opposed to individual seats, is rented out for a specific flight or flights. There is no limit to the destinations or time schedule. It is a completely customizable service.

“Shared Charter” is where an entire aircraft, as opposed to individual seats, is rented out for a specific flight or flights, but the individual or company financially responsible for the entire aircraft rental is making empty seats available to other members.

“Social Jet Circle” is a group of registered users utilizing the present invention designated by the user. The Social Circle can be overlapping and concentric social circles such as “family,” “work,” “club,” etc. The largest social circle includes all the registered users of the application. Participants who are booked on a flight can send their trips and routes to their friends and social circles via email and text, or, in another example, through a private social network that communicates with the application. Through the use of a public or private network, the participants can share updates with their circle of friends.

“Shuttle Charter” is where seats on an aircraft, as opposed to the entire aircraft is rented out for a specific flight or flights. Many shuttle charters run on regular schedules between certain destinations.

“Social Media” is the ability to share content with one or more participants in a social network with the user.

### Overview of Client Selections:

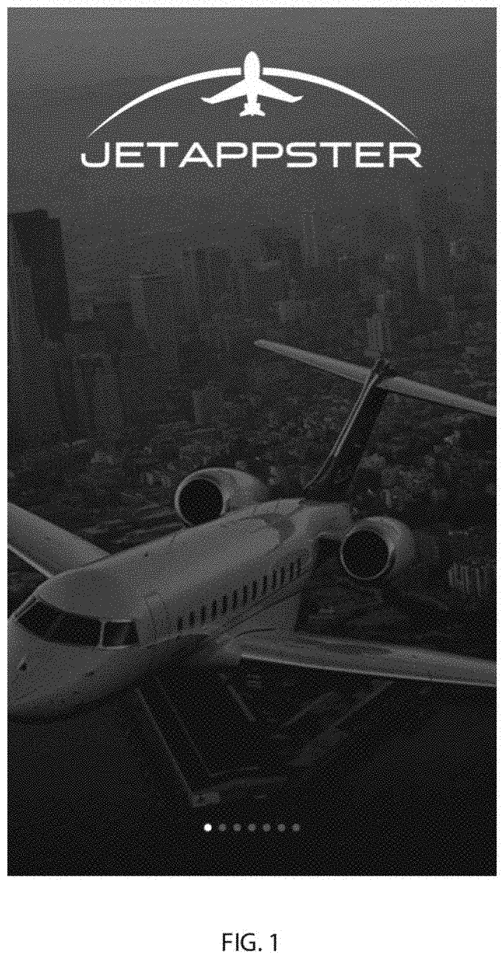

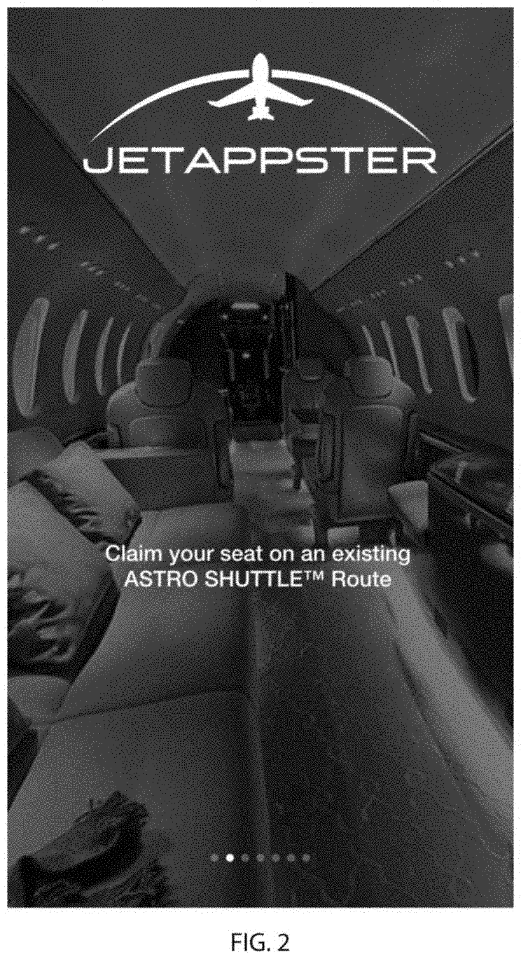

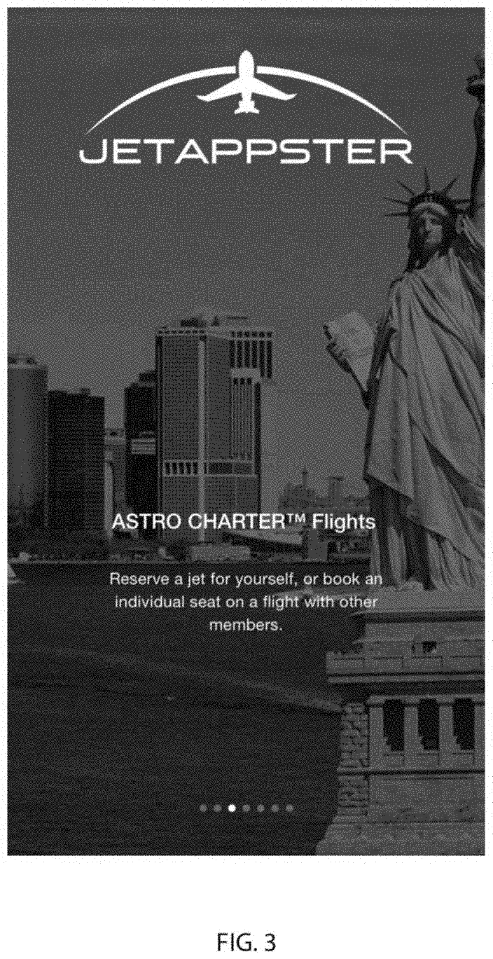

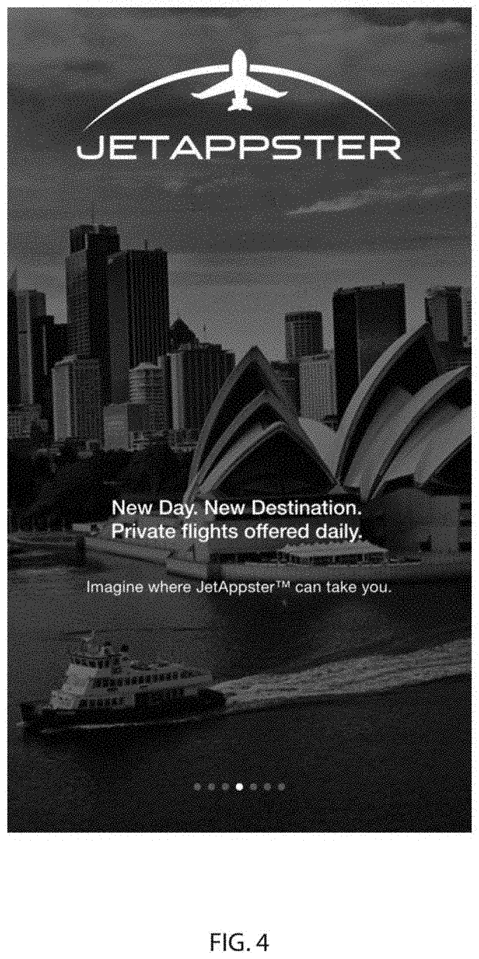

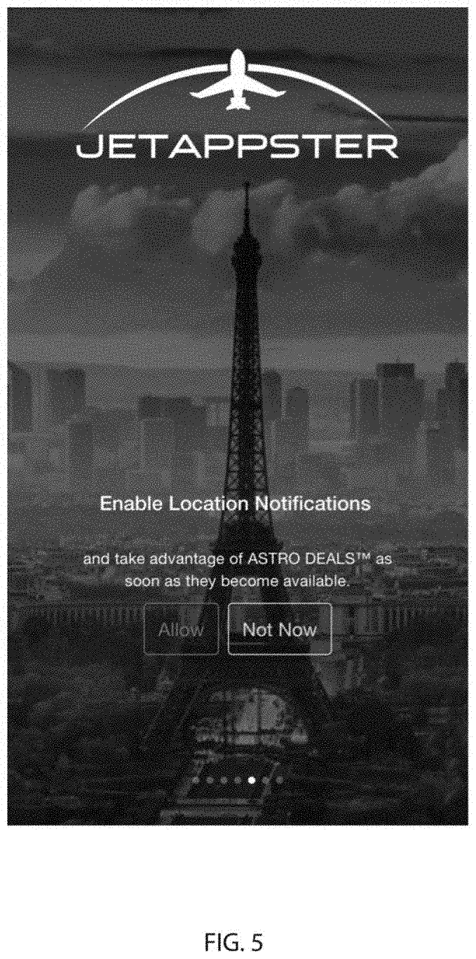

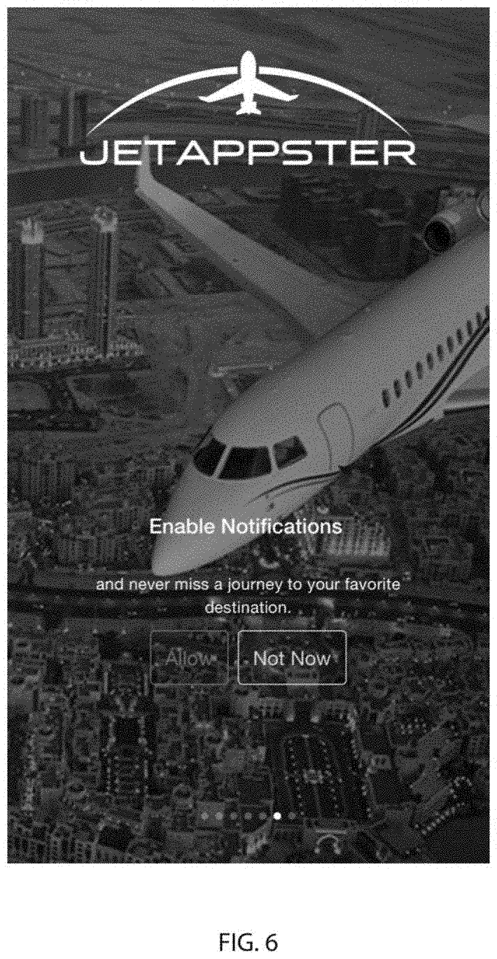

A splash screen usually appears while the software utilizing the present invention is loading. The software in the application employing the present invention is being reduced to practice and is branded as the JetAppster™ application (“app”). FIG. 1 to FIG. 6 are screenshots of the flow of the application illustrating the major components of the charter reservation system. The flow starts with a splash screen with one or more graphical control element consisting of window containing an image, a logo, and the current version of the software.

The process continues offering multiple choices to the user “Intro,” “Profile,” “Charter,” “Deals,” “Shuttle,” and “Email,” as shown. Each of these choices are now described.

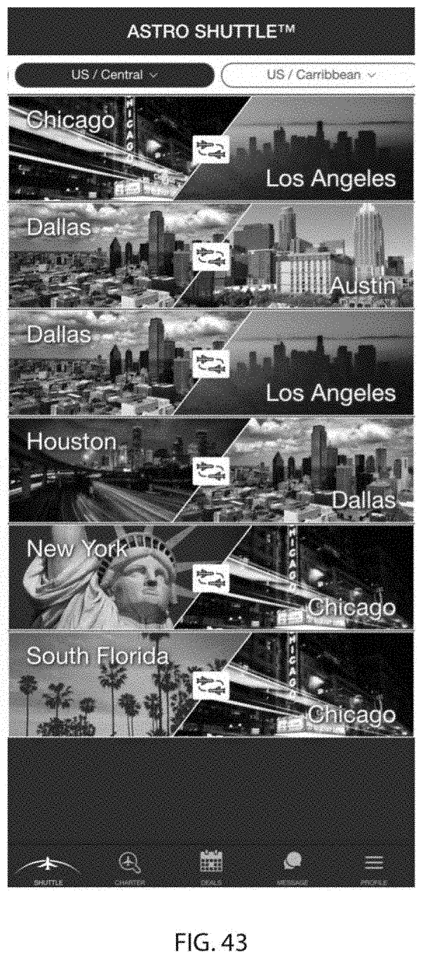

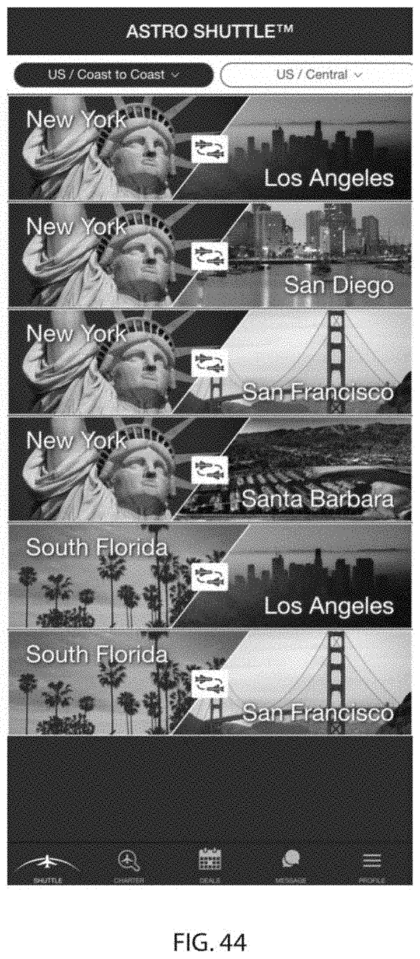

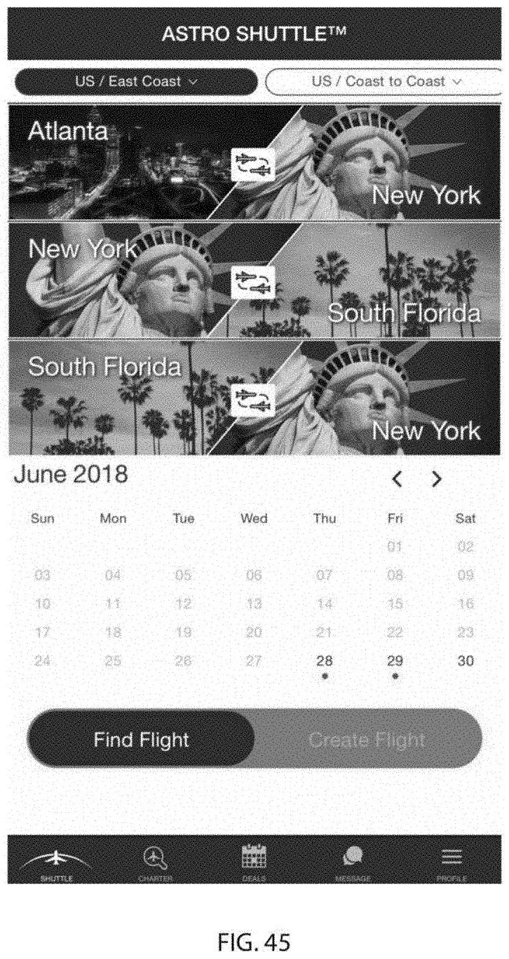

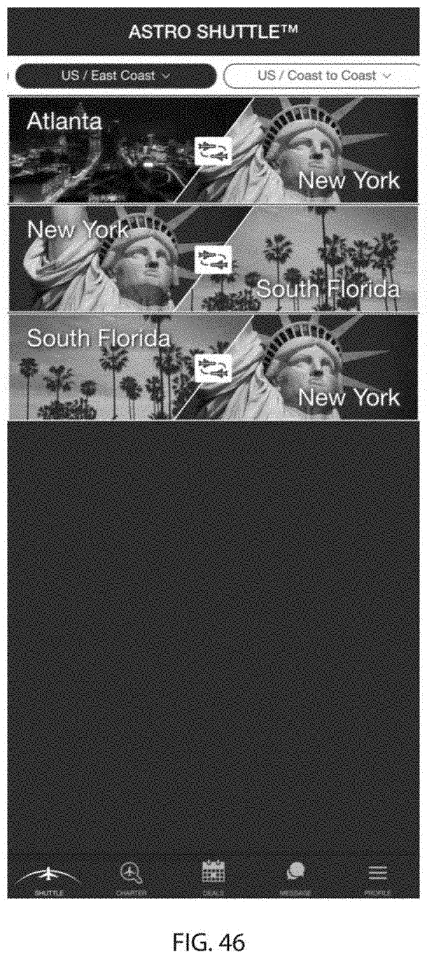

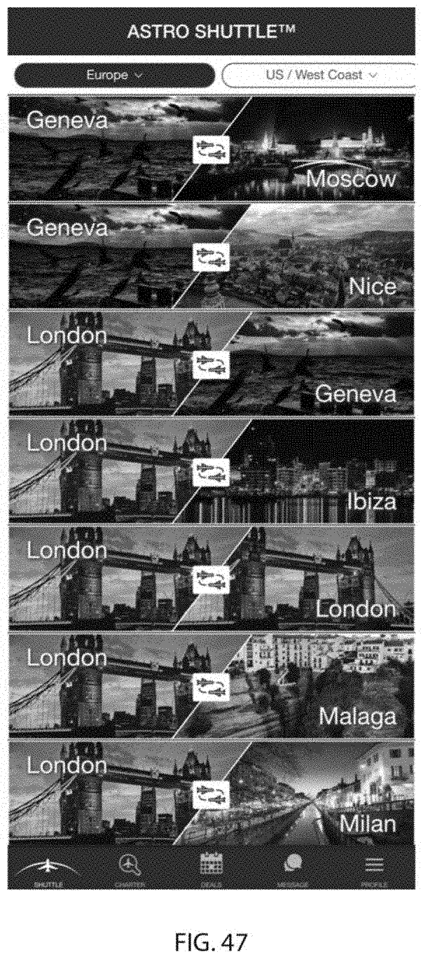

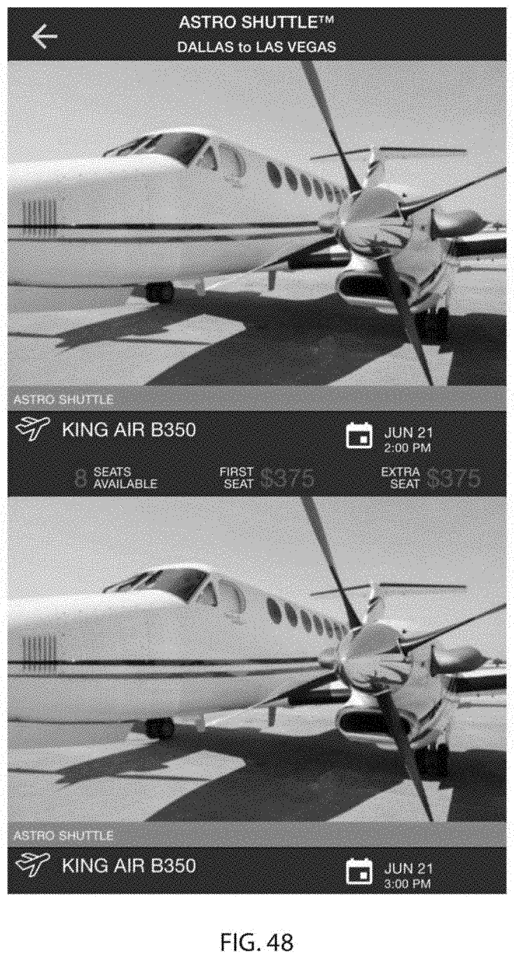

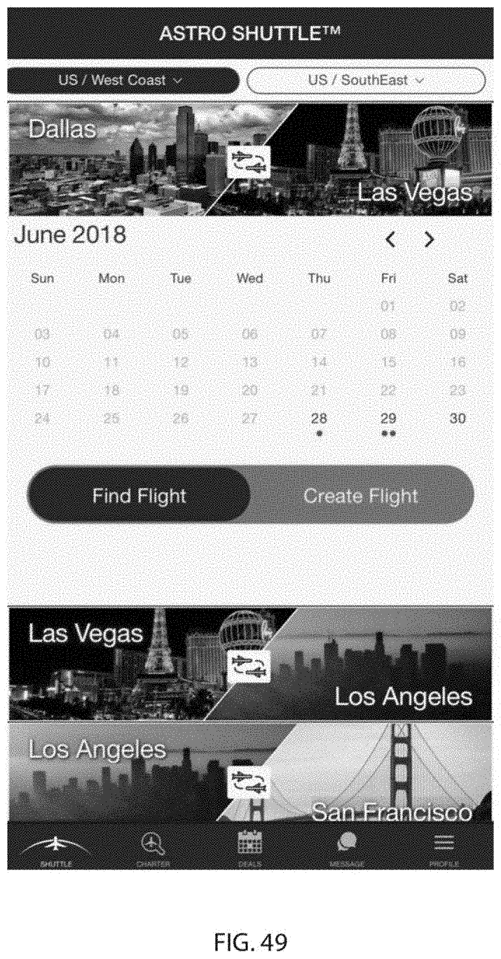

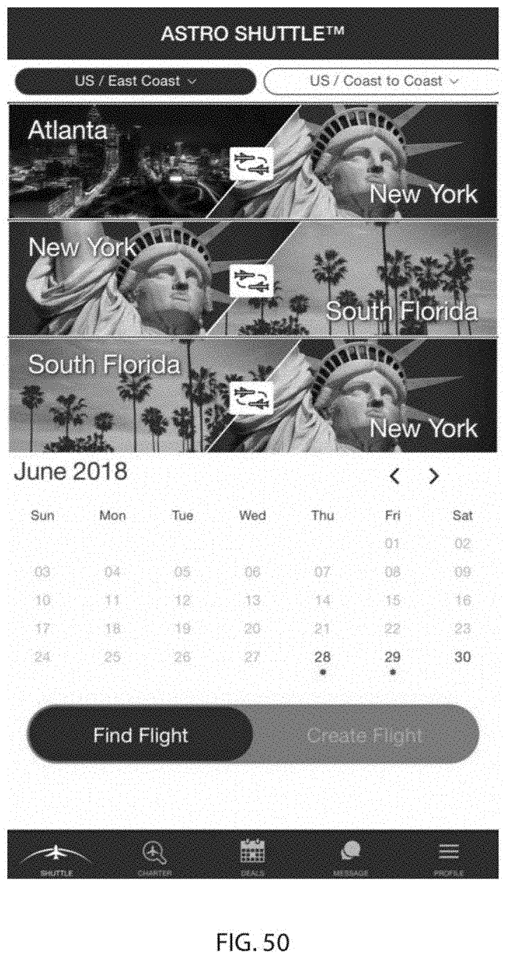

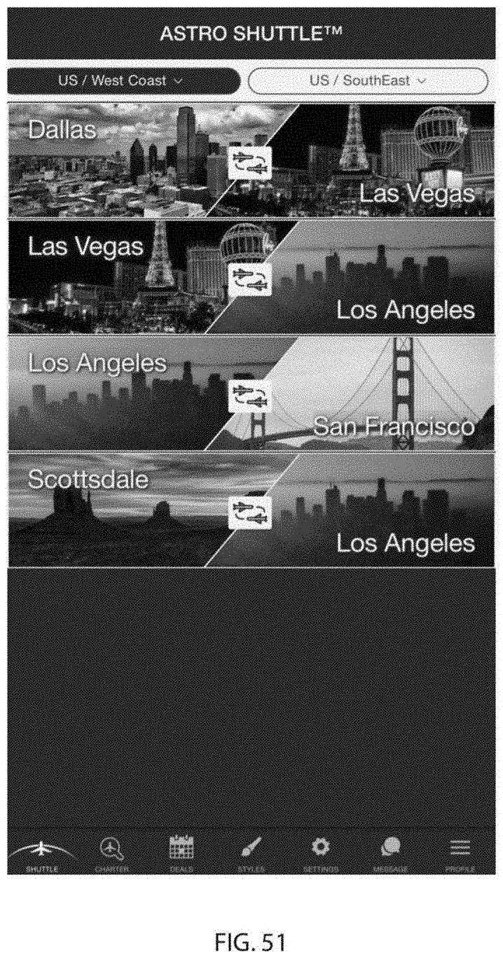

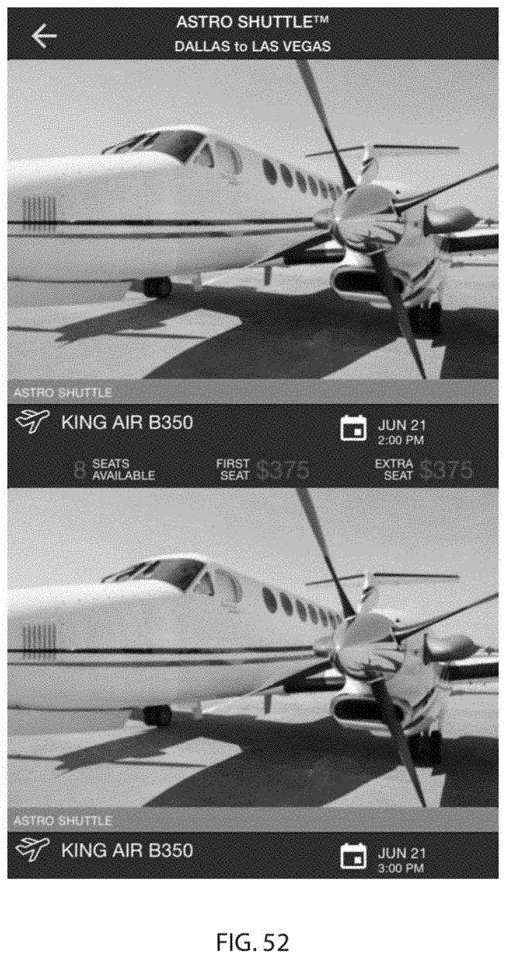

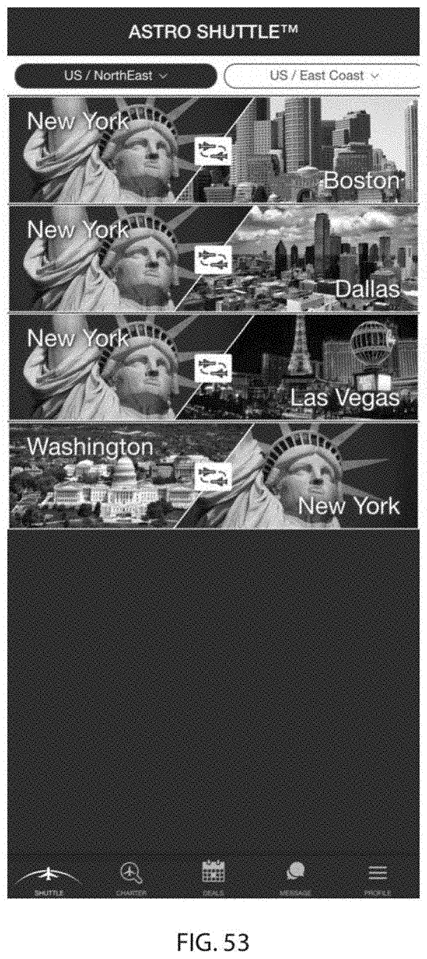

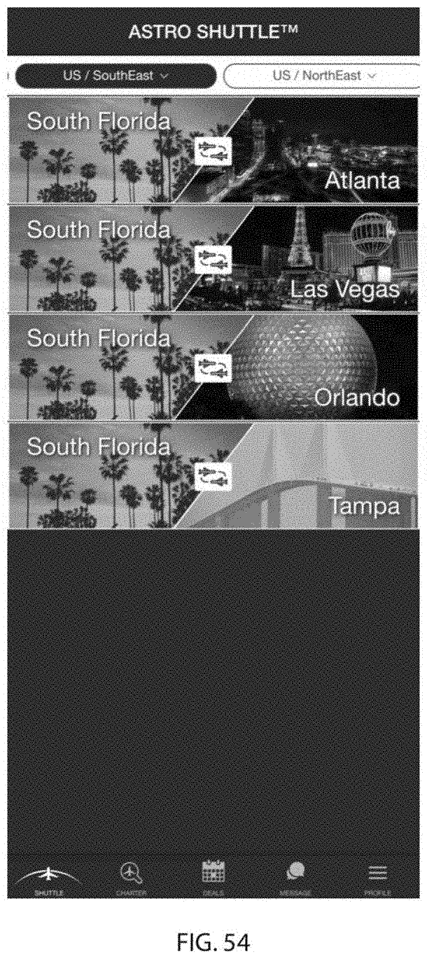

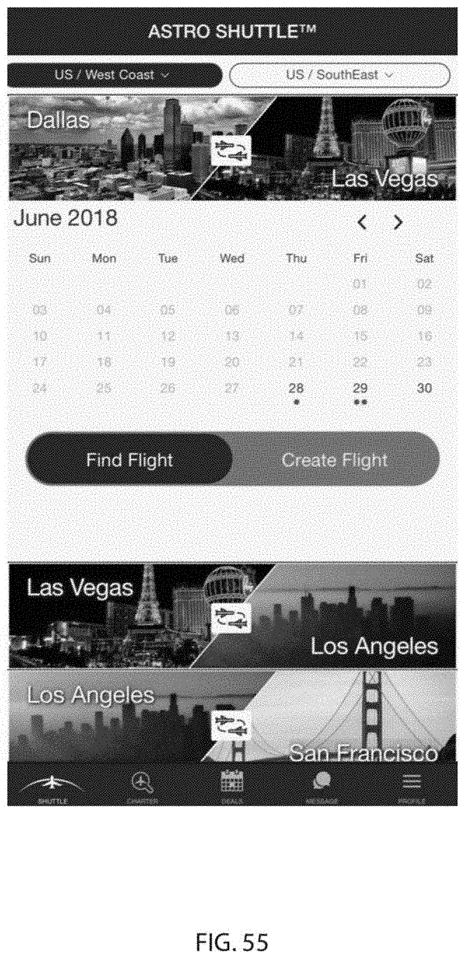

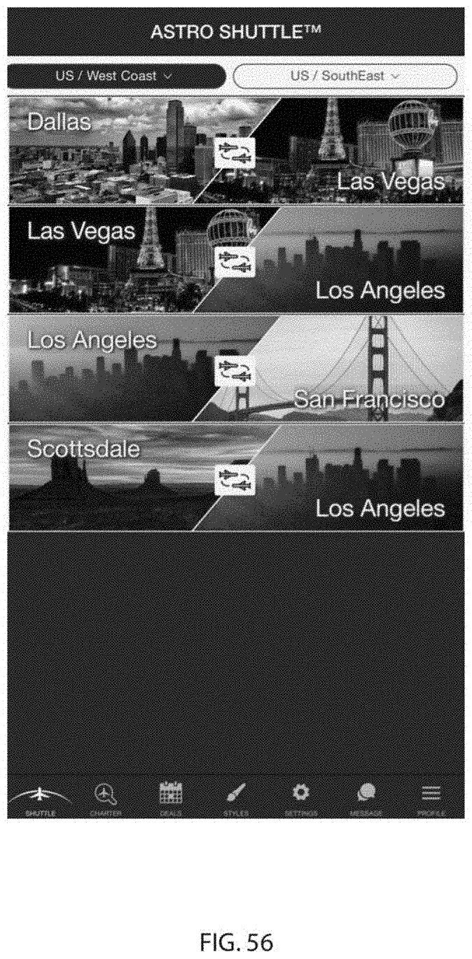

In response to the user selecting “Shuttle,” illustrated in FIGS. 43-56, various regions may be shown, such as “United States,” “Intercontinental,” “Europe,” “Middle East,” and “Holiday Shuttles.” The “United States” region in one example is further broken down into sub-regions “Southeast,” “East Coast,” “Caribbean,” “Central,” “Coast to Coast,” “Northeast,” and “West Coast.”

Once a region and optional sub-region is selected by the user, the “Book Shuttle” screen comes up. The user can “Find a Flight,” “Choose Date,” and “Choose a Leg” of a flight.

In another example, the user can “Create a Flight,” “Choose Date,” “Choose Plane,” and “Finalize Flight Details,” i.e. “Time,” “# of Seats,” “Payment,” “Accept Terms.”

In one example, “Create a Flight.” means “Create Your Own Shuttle” with date, city of origin, and city of destination. To “Create Your Own Shuttle,” a minimum number of seats will need to be purchased. The left-over seats are shown as being available in a preexisting shuttle. The user who created their own shuttle will get flight credits, or in some cases cash, for any available seats sold. Giving flight credits is an incentive for users to return.

In one example, “Charter” allows the user the ultimate flexibility to choose departure, choose arrival, choose date, choose time, etc. The user may select “convert” (not shown) to convert a “Charter” into a “Shared Charter.” This allows the user to recoup the costs of the seats not needed. The user who created their own shuttle will get flight credits, or in some cases cash, for any available seats sold. Giving flight credits is an incentive for users to return. Otherwise, the user initiating the charter is financially responsible for the entire charter.

### Social Media:

The present invention allows registered users to chat with other registered users or just a group of friends within the app. This allows registered user to sell seats and plan trips with friends. The registered user can post available seats on a Shuttle or Shared Charter to only their friends. If their friends are not interested in joining a Shuttle or Share Charter, the registered user can increase the group by sending invites to a larger circle of users.

In one example, the size of the group of registered users is a “Social Air Circle.”

### Geo Fencing:

The present invention allows registered users to receive notifications based on their current geographic location for available seats on Shuttle or Shared Charter. This helps greatly make registered users aware of available seats based on city of origin where they may be staying.

### Client-Side Flow:

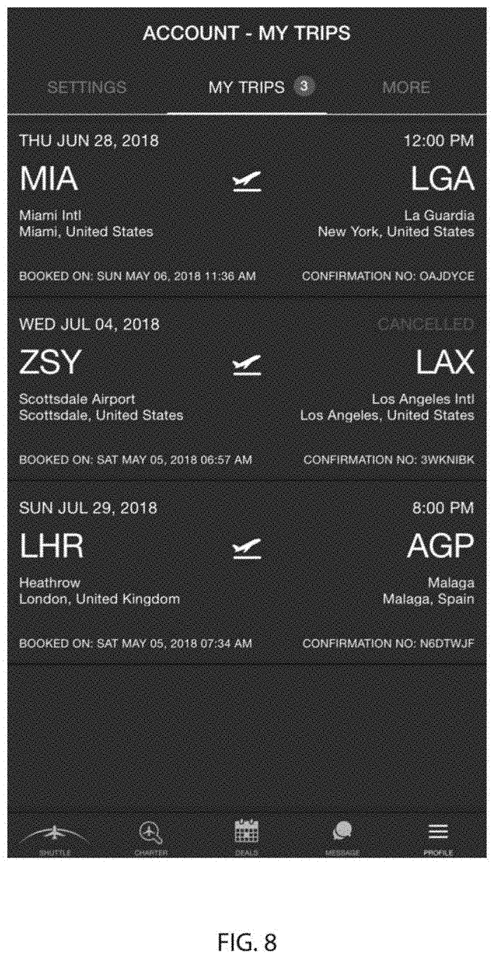

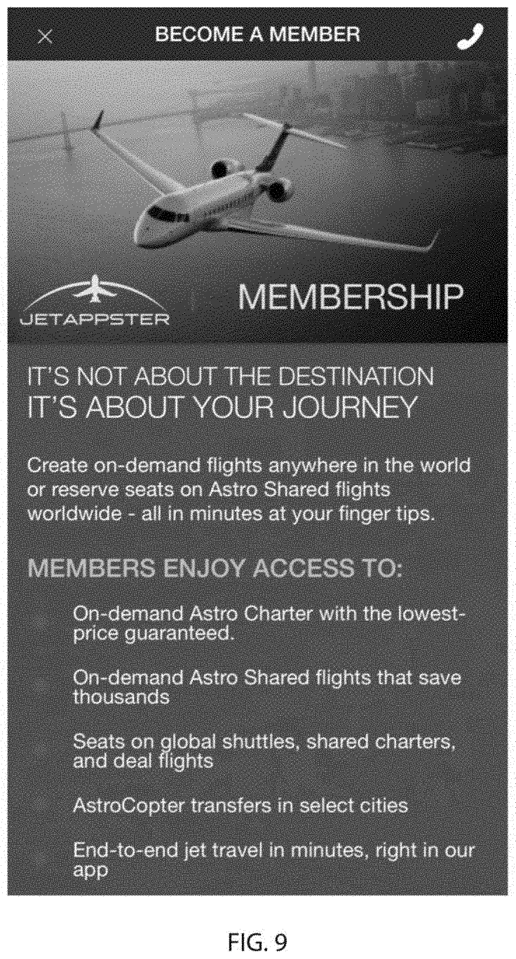

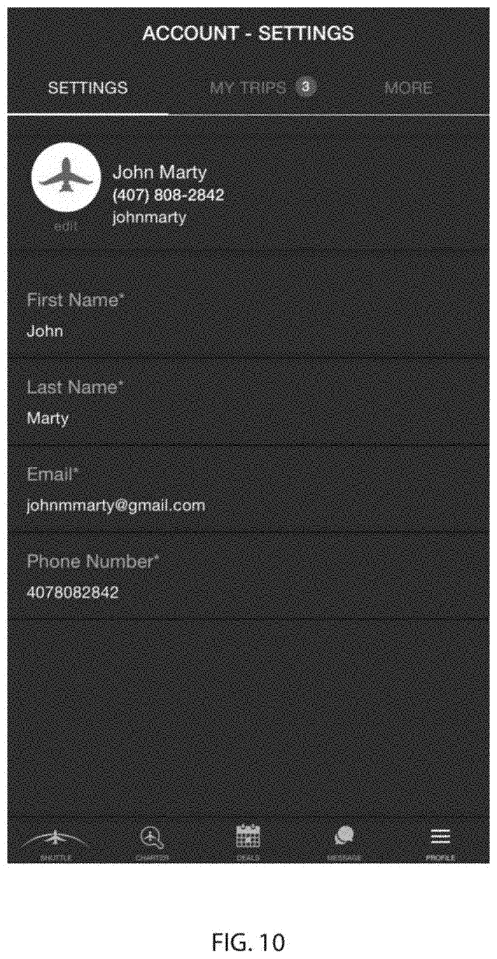

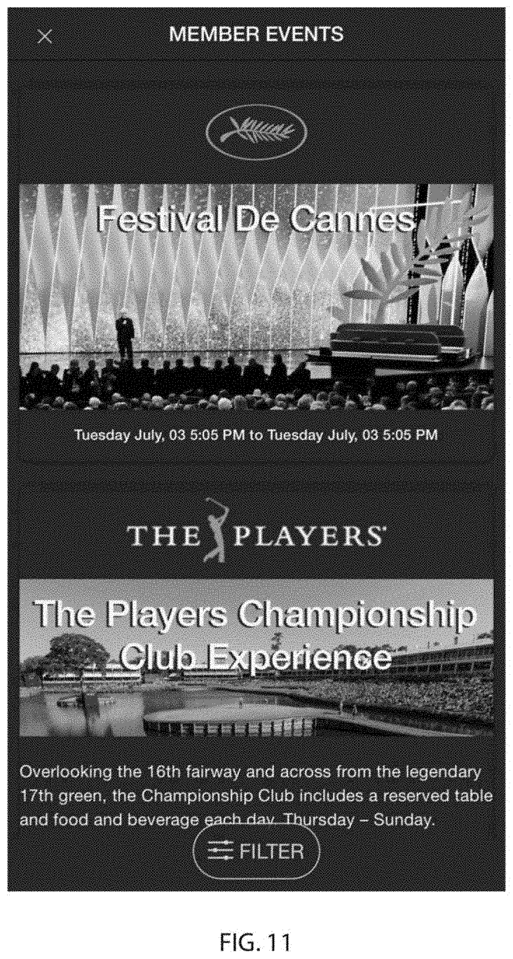

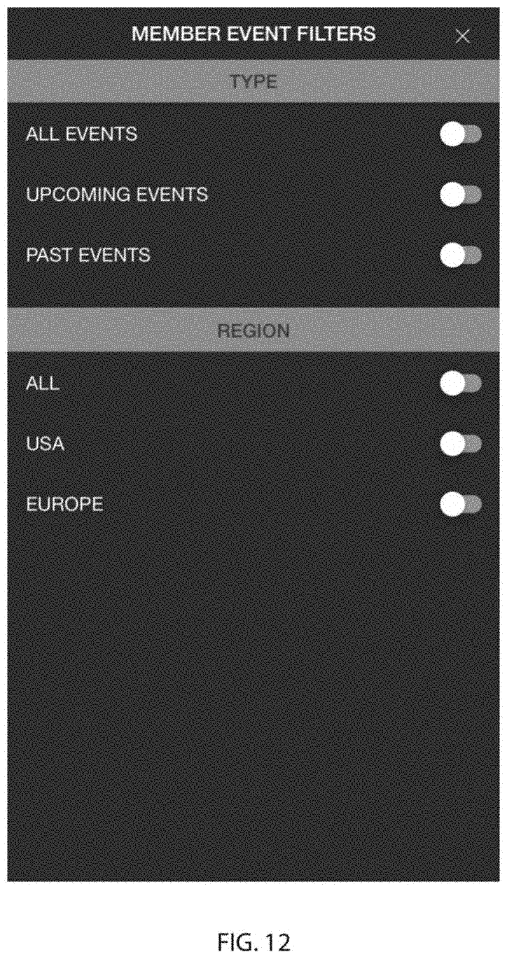

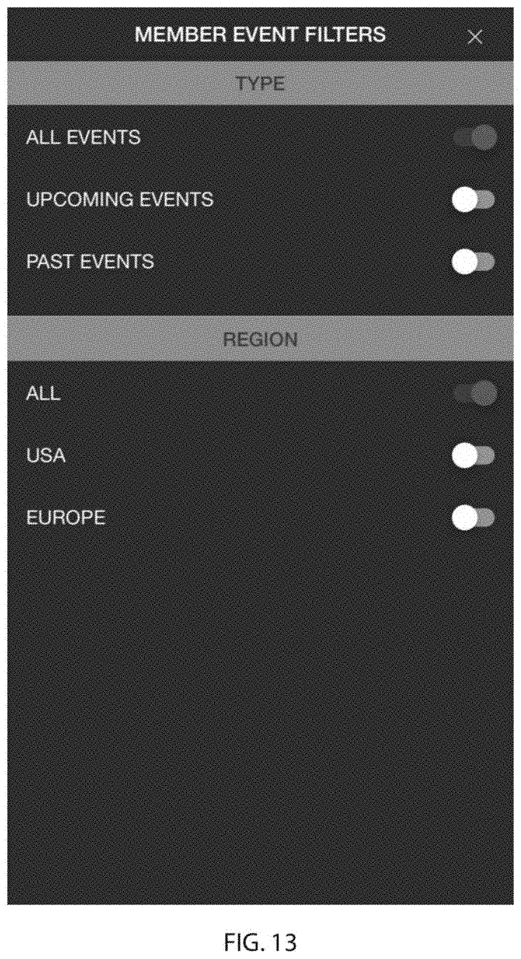

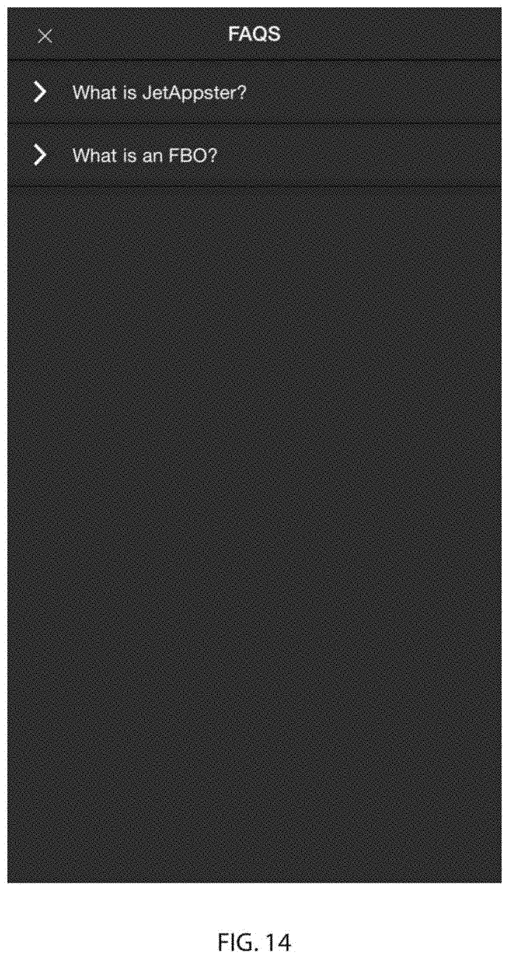

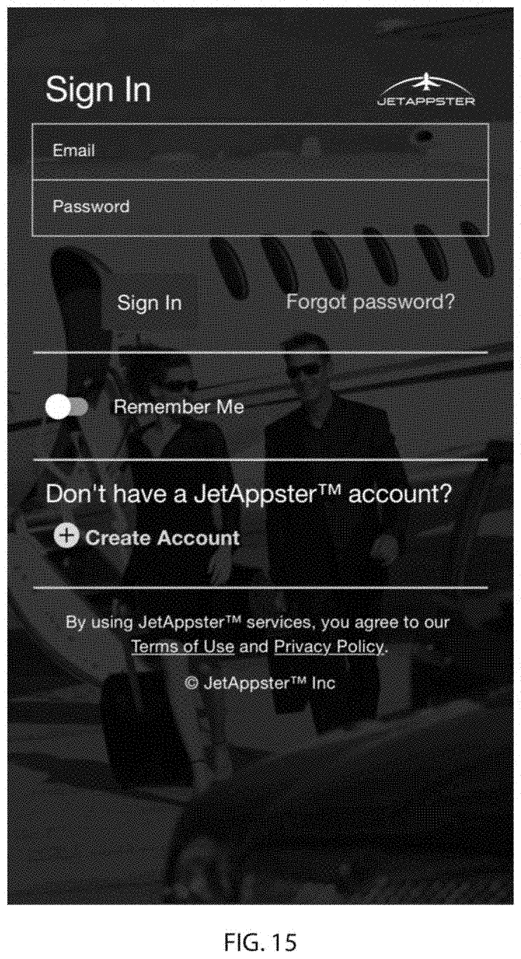

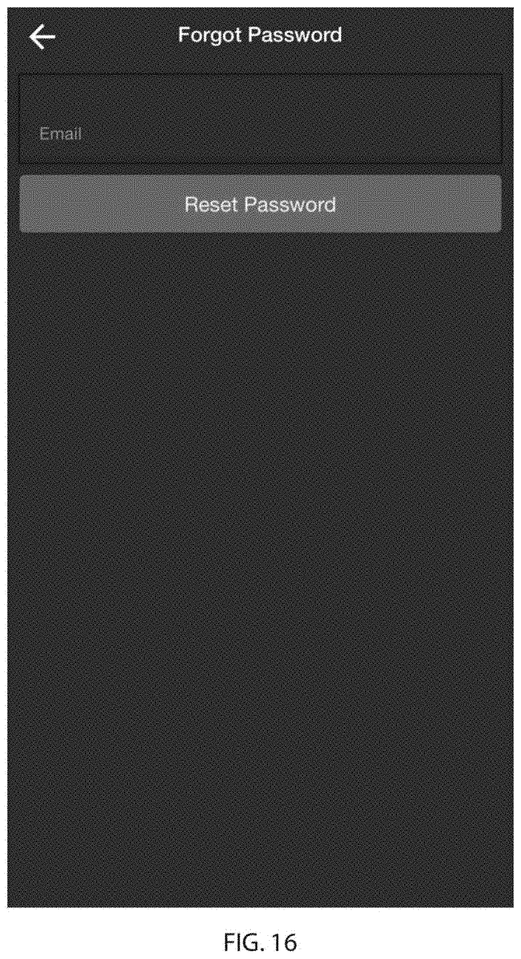

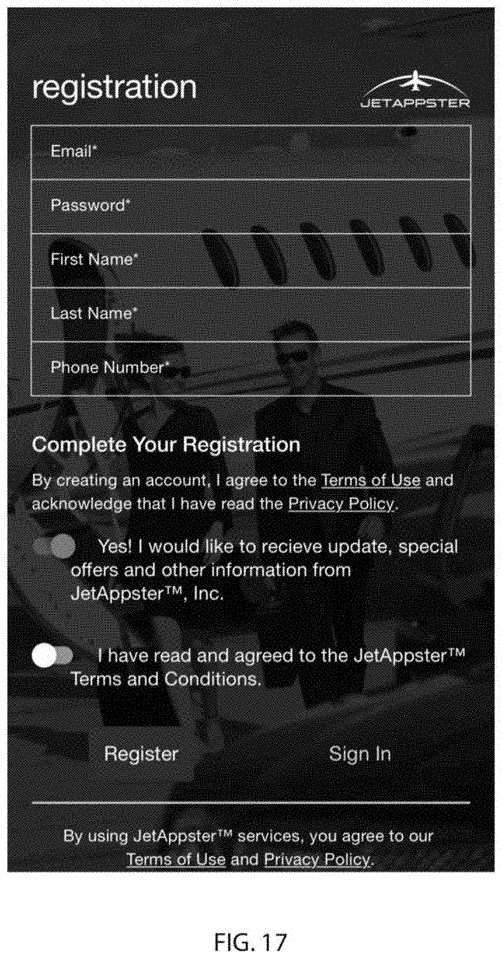

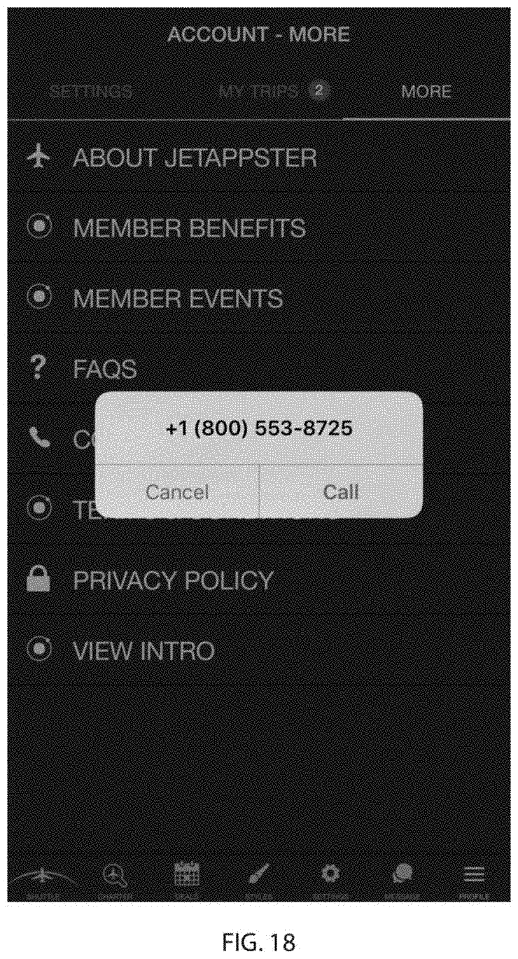

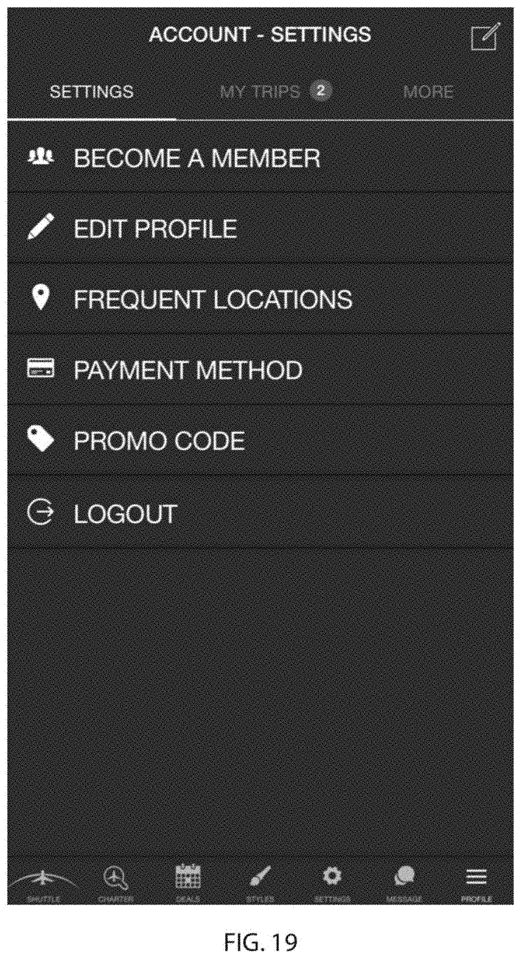

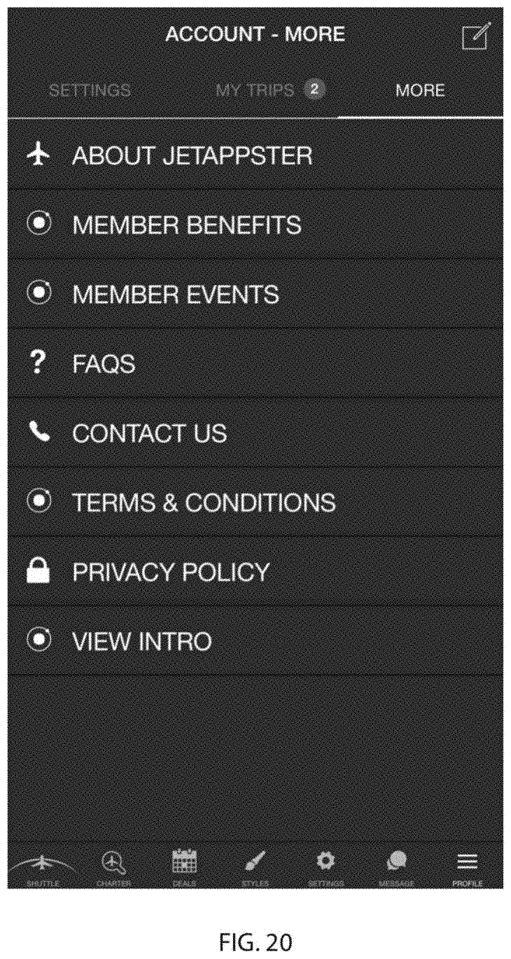

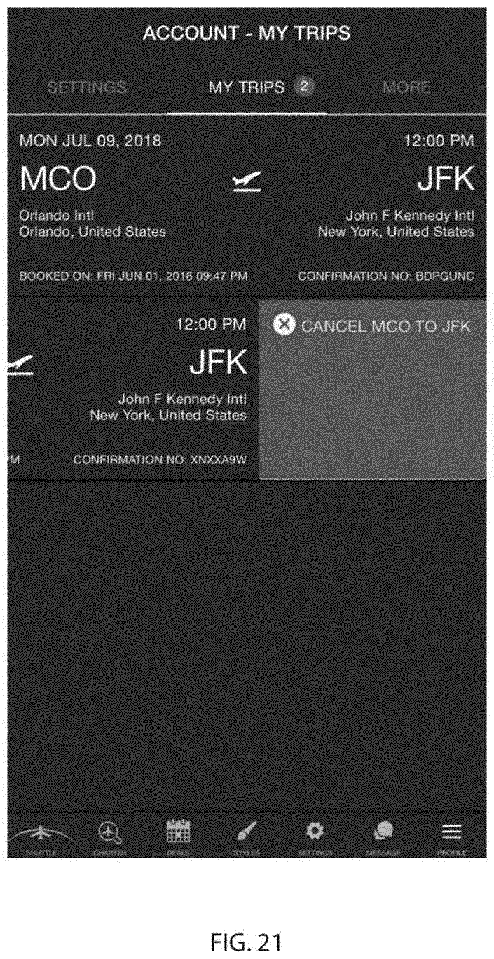

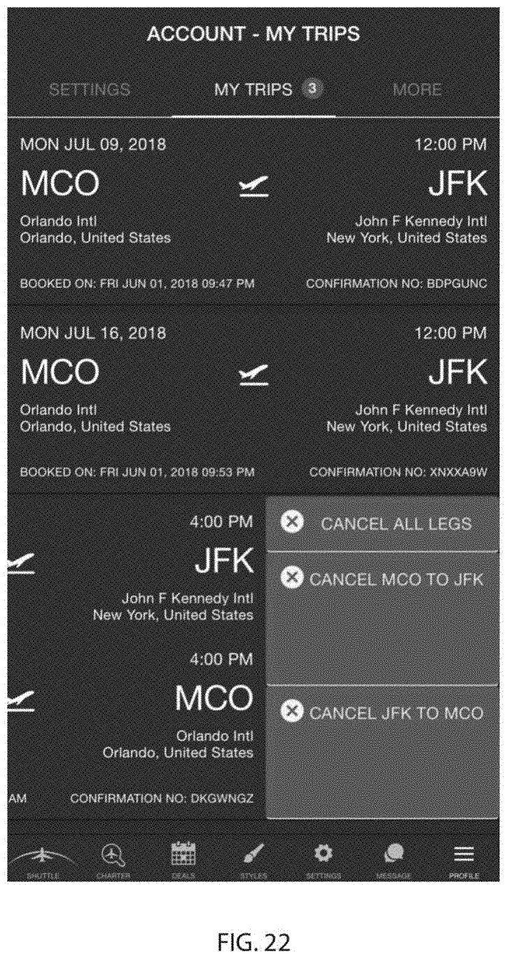

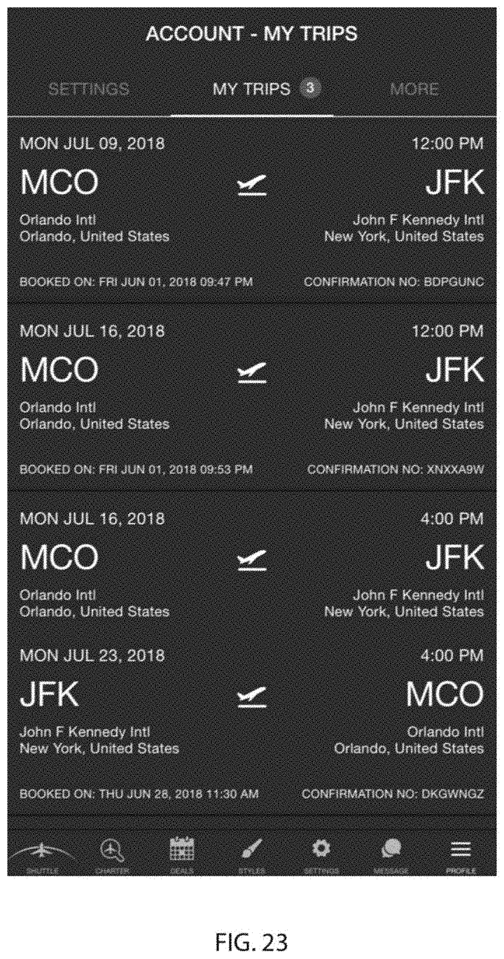

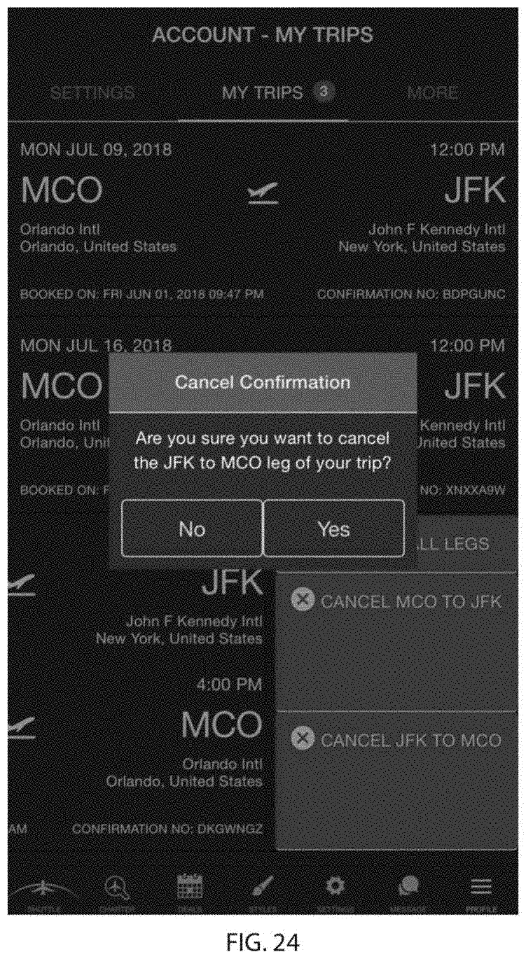

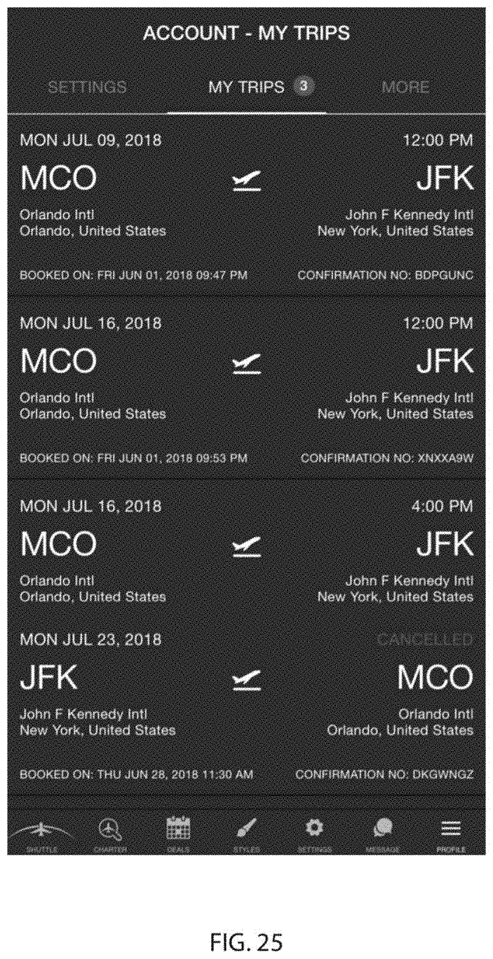

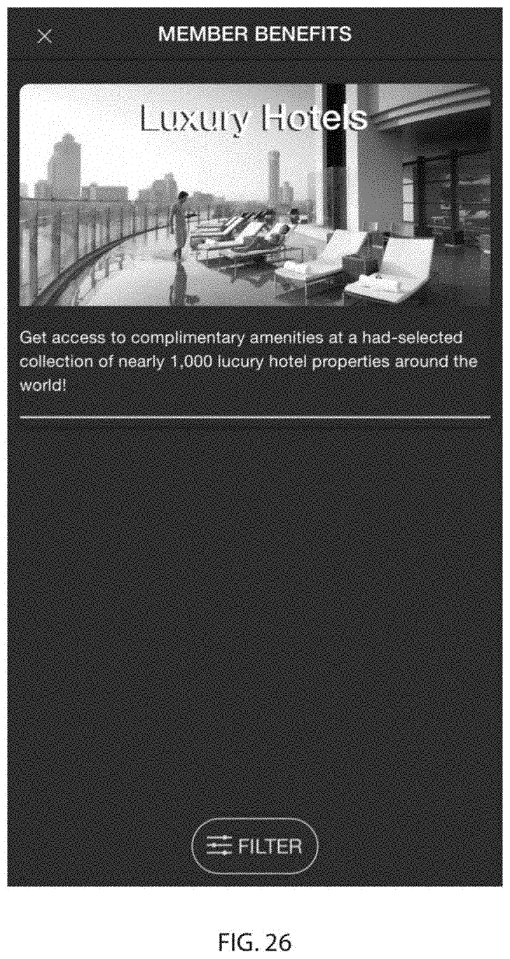

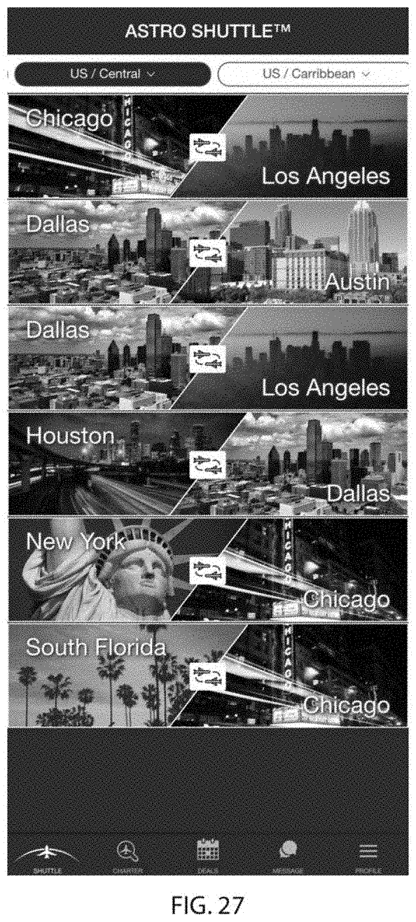

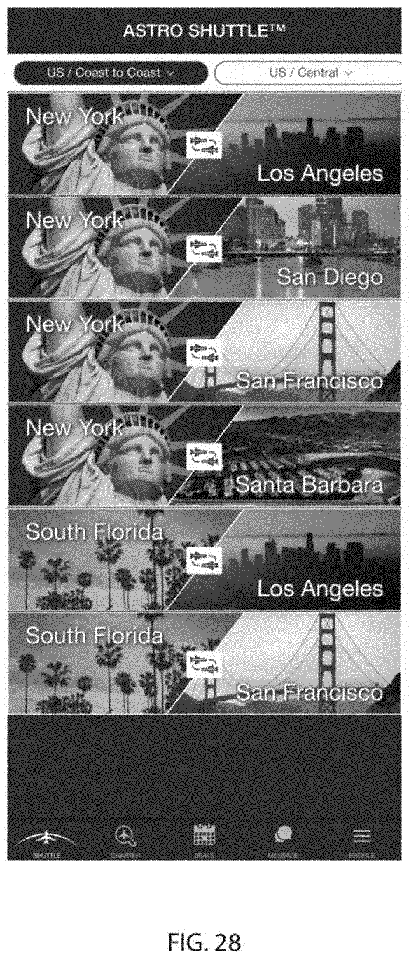

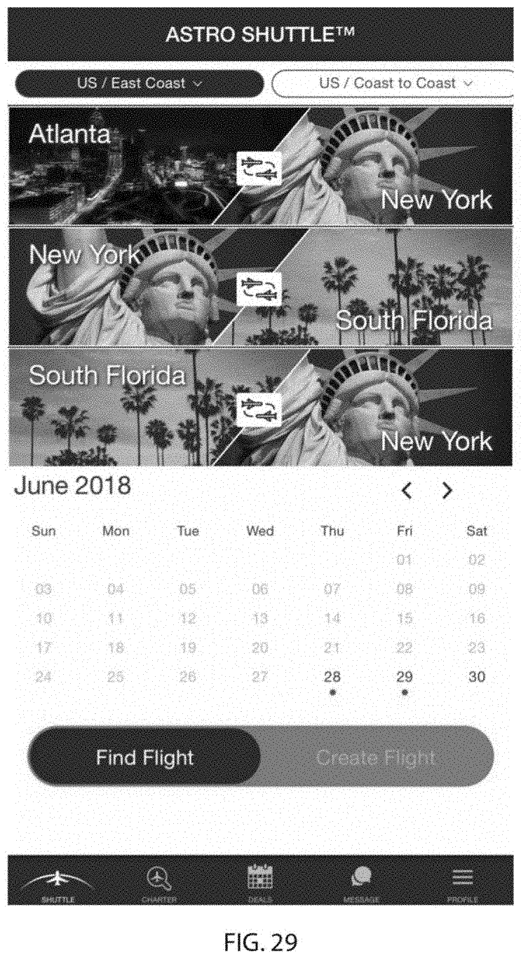

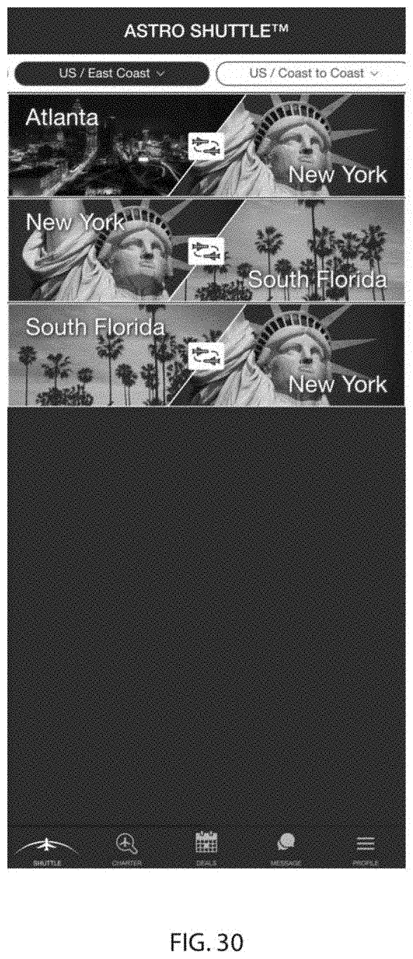

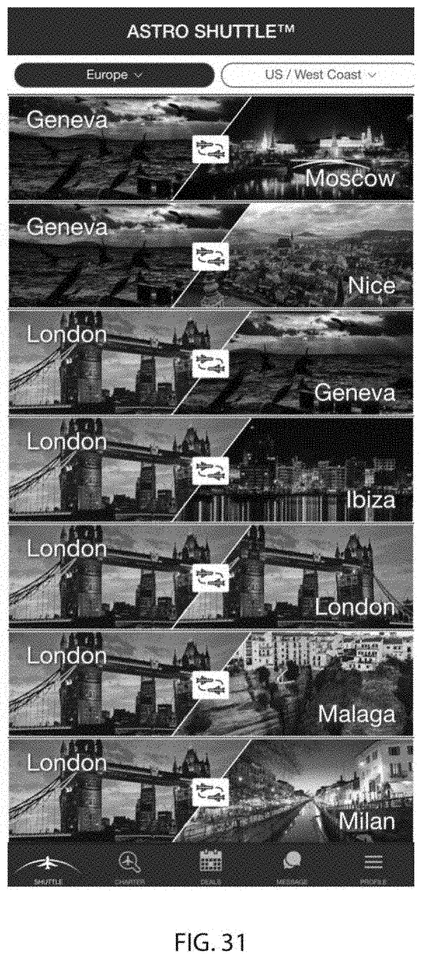

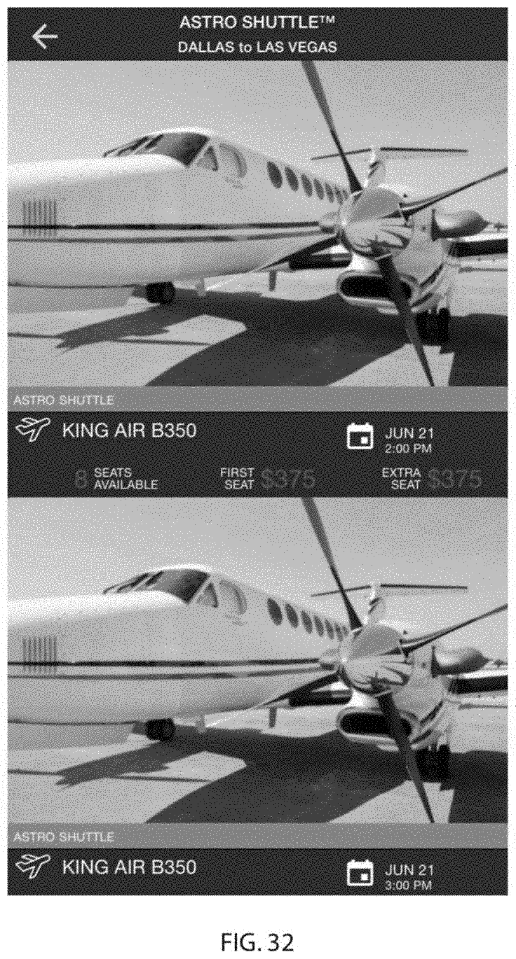

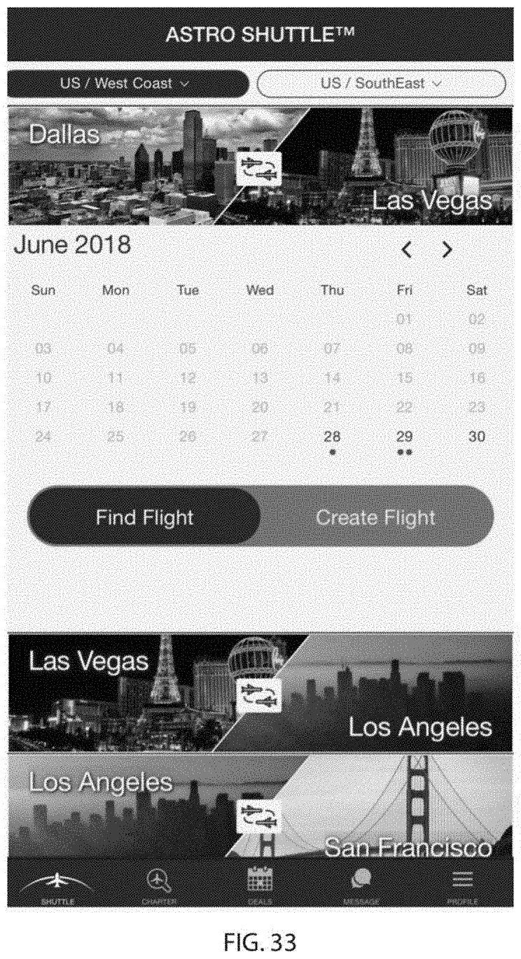

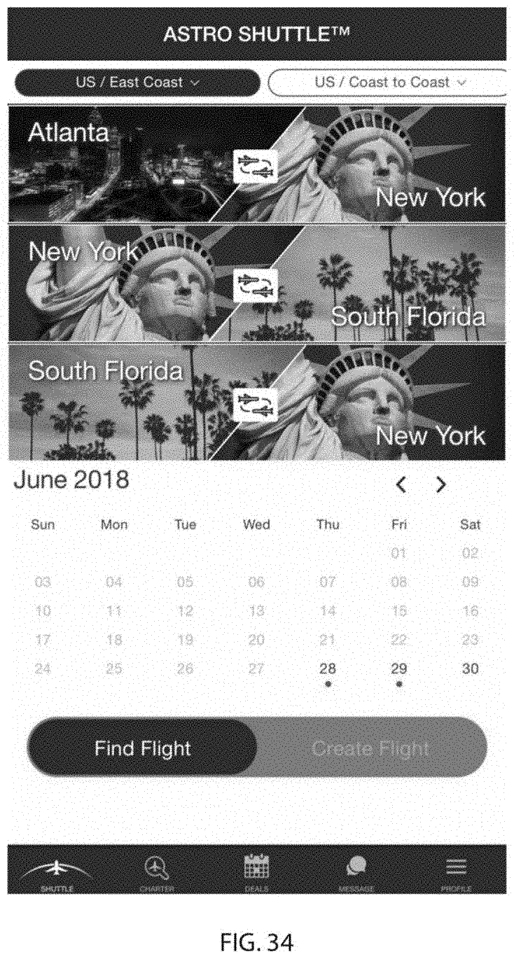

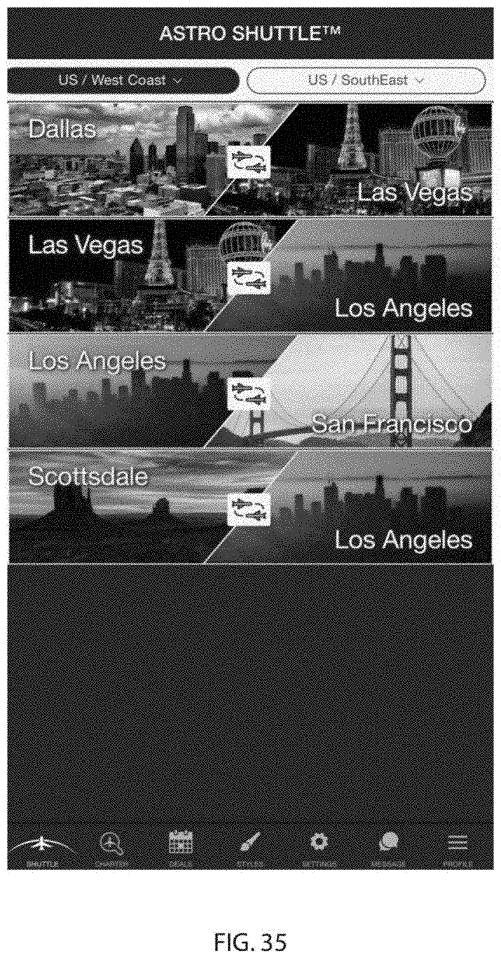

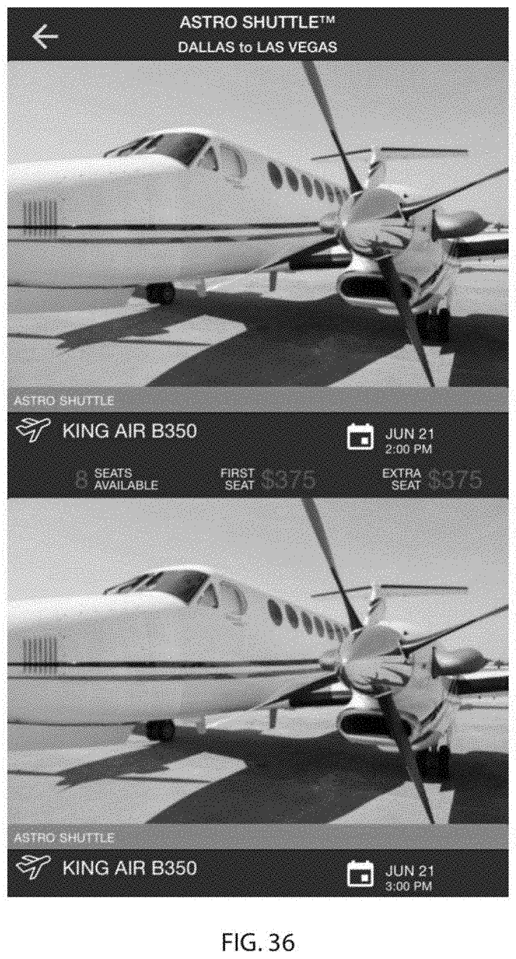

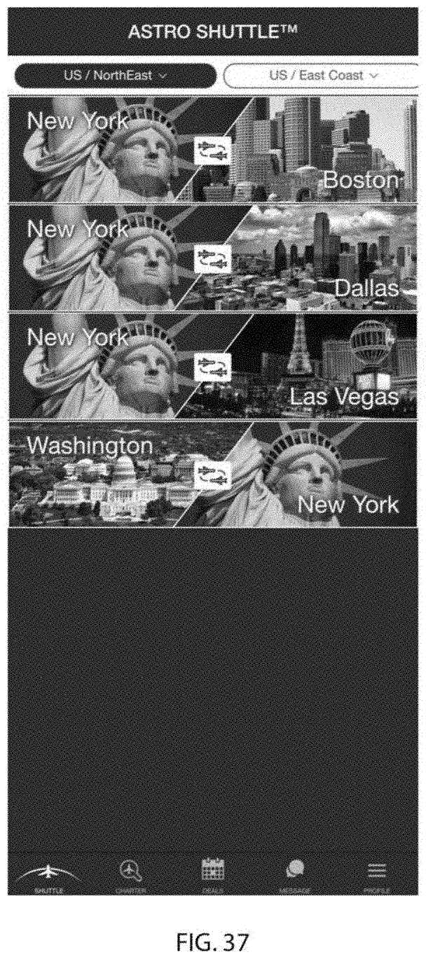

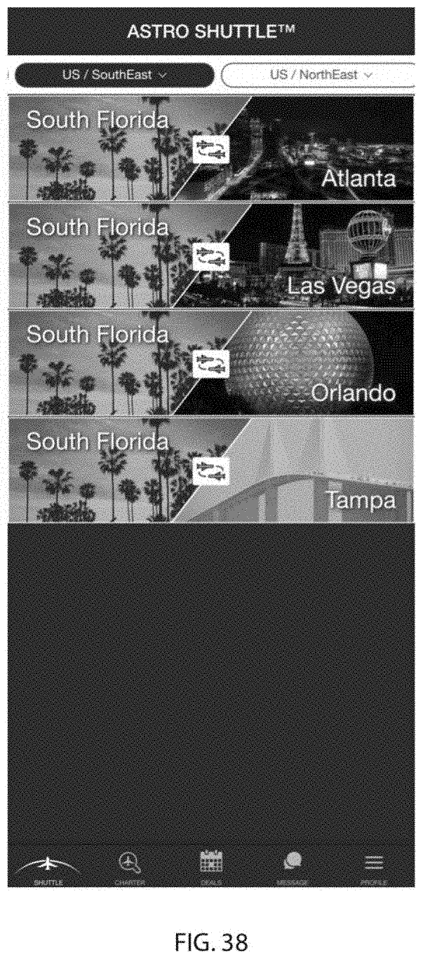

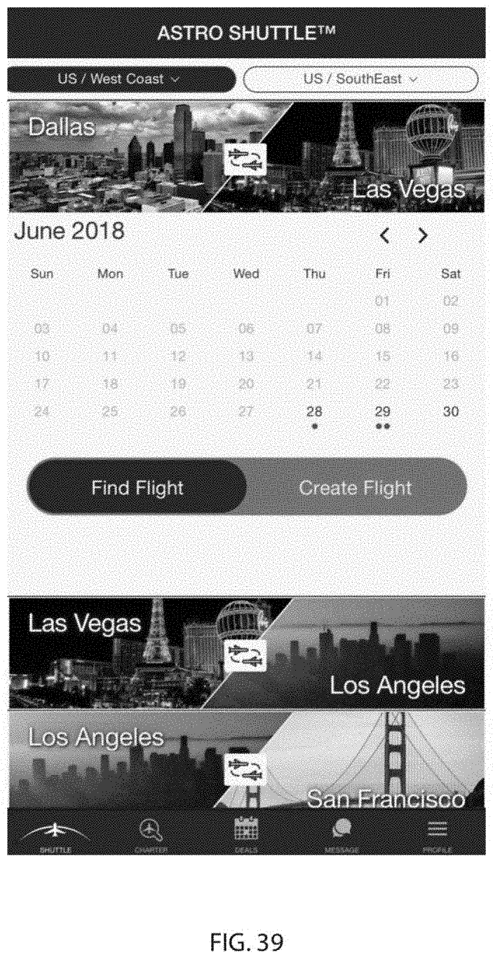

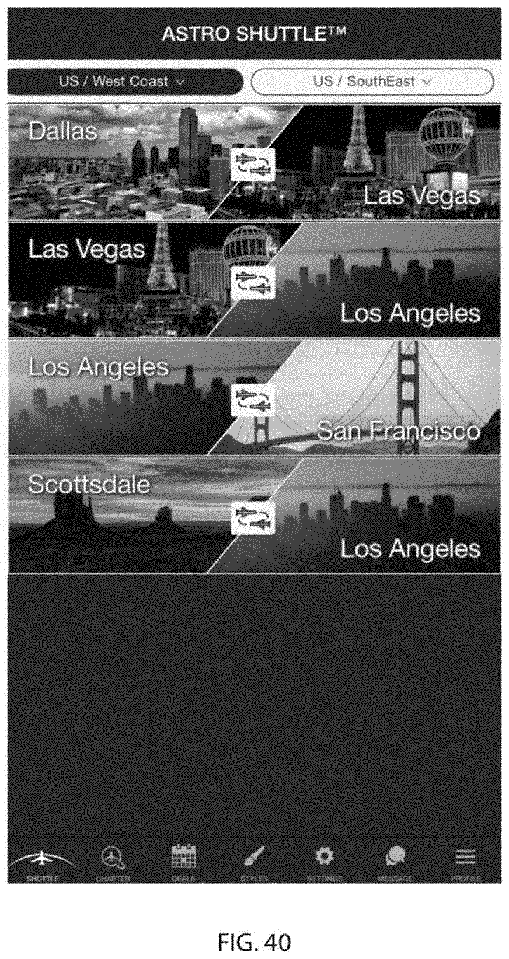

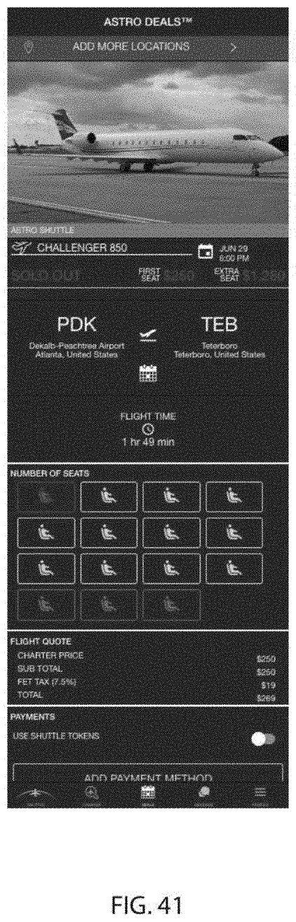

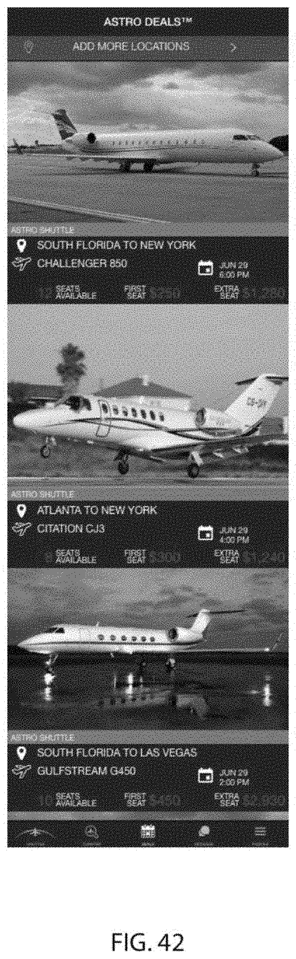

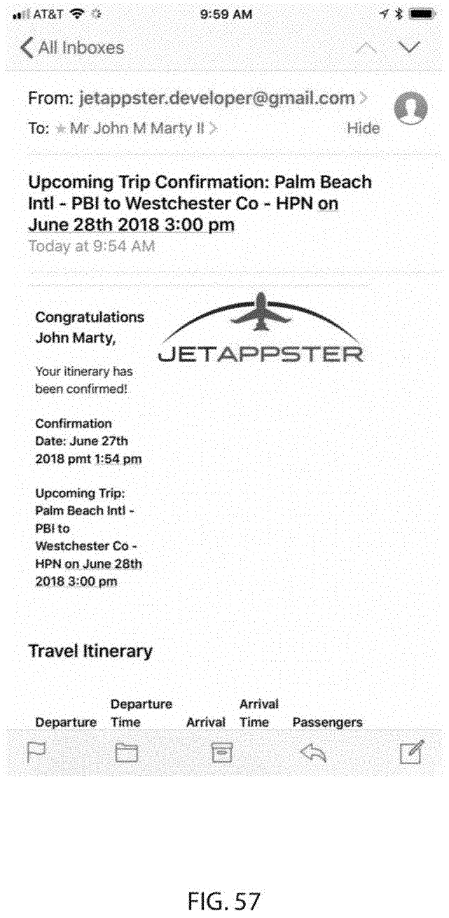

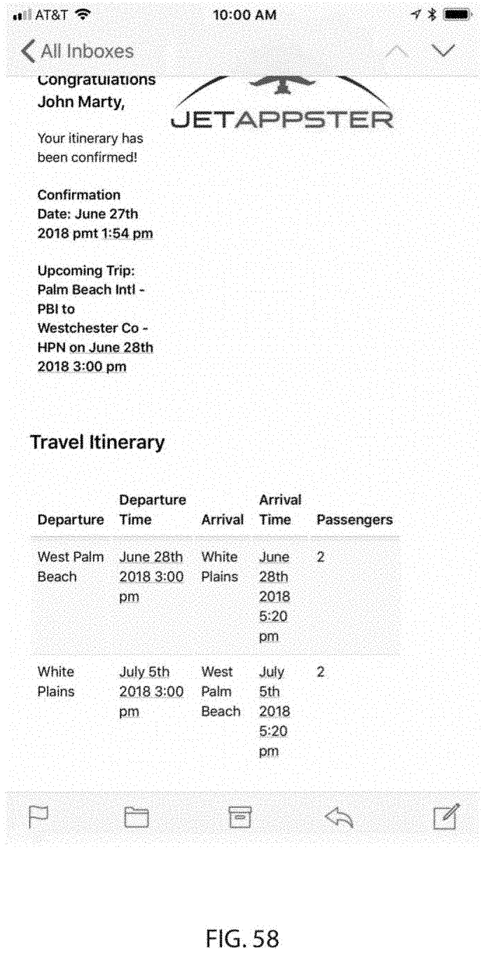

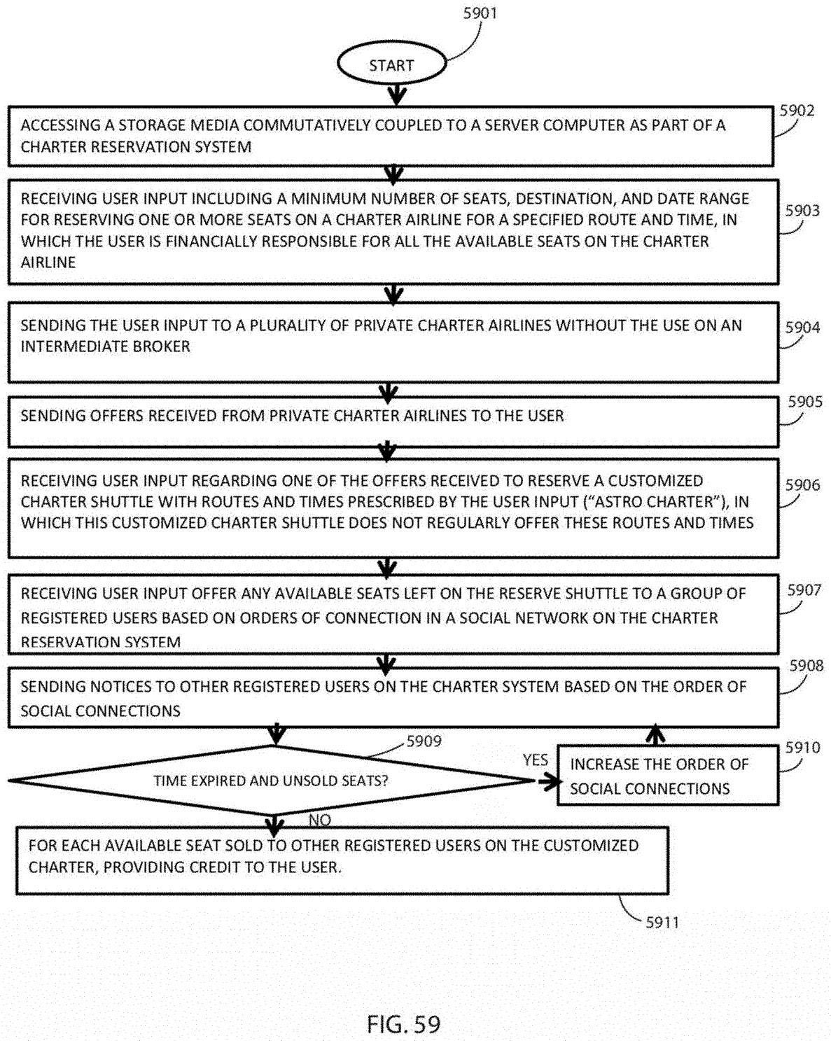

FIG. 59 is a flow diagram on a client device, such as a smart phone, of the major embodiments shown in FIGS. 1-58. Shown are areas that allow anonymous access, registered access, and member access areas.

The app on a client device starts with splash screens as described above. From the splash screen there are five major areas “Intro,” “Profile,” “Charter,” “Deals,” “Shuttle,” and “Email.” Underneath each of these major areas are further menus as shown.

“Profile” corresponds to screens on pages 6-26.

“Charter” corresponds to screens on pages 27-40.

“Deals” corresponds to screens on pages 41-42.

“Shuttle” corresponds to screens on pages 43-56.

“Email” corresponds to screens on pages 57-58. These example emails are sent by the system.

As shown in FIG. 59, a flowchart is provided illustrating the process of the computer-implemented method of present invention which takes place on a server computer for creating charter airline reservations. The process starts at step 5901 and accesses a storage media commutatively coupled to a server computer as part of a charter reservation system at step 5902. At step 5903, user input is received including a minimum number of seats, destination, and date range for reserving one or more seats on a charter airline for a specified route and time, in which the user is financially responsible for all the available seats on the charter airline. Thereafter, at step 5904, the user input is sent to a plurality of private charter airlines without the use on an intermediate broker.

Once the user input is sent to the airlines, users are sent offers received from private charter airlines at step 5905. At step 5906, the system receives user input regarding one of the offers received to reserve a customized charter shuttle with routes and times prescribed by the user input (“Astro Charter”), in which this customized charter shuttle does not regularly offer these routes and times.

If there are any available seats left on the reserve shuttle, the system receives user input at step 5907 to offer the available seats to a group of registered users on the charter reservation system. Then, notices are sent at step 5908 to other registered users on the charter system based on the order of social connections. At step 5909, a determination is made as to whether there are still unsold seats after a predetermined period of time expires. If seats remain, the order of social connections is increased to offer the seats to a larger group of registered users at step 5910 and the system repeats at step 5908. If no seats remain, a credit is provided to the user at step 5911 for each available seat sold to other registered users on the customized charter.

It is to be understood that the group of registered users on the charter reservation system may be one of family, work, friends, or a combination thereof. When unsold seats remain, the seats may be specifically offered to only a group of registered users on the charter reservation system located within a predetermined geolocation of the origination city for the route of the customized charter.

### Server-Side Flow:

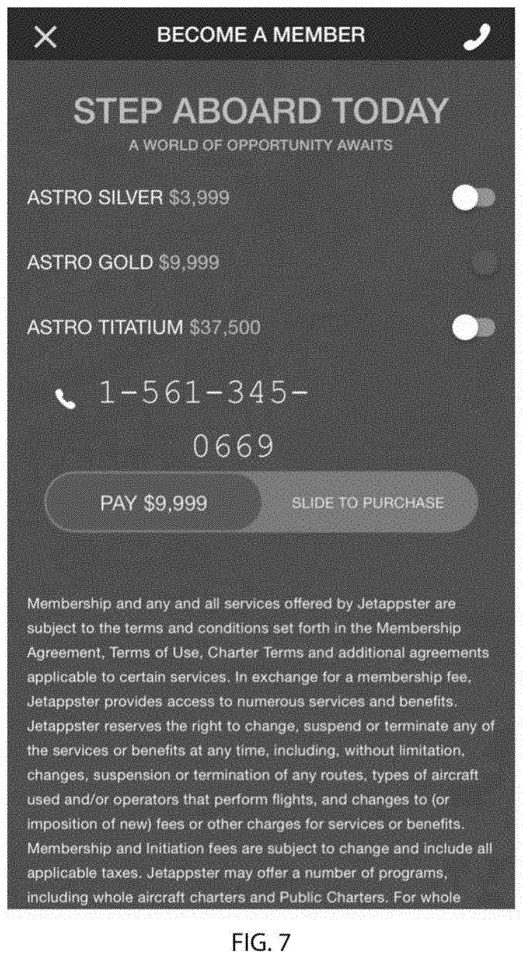

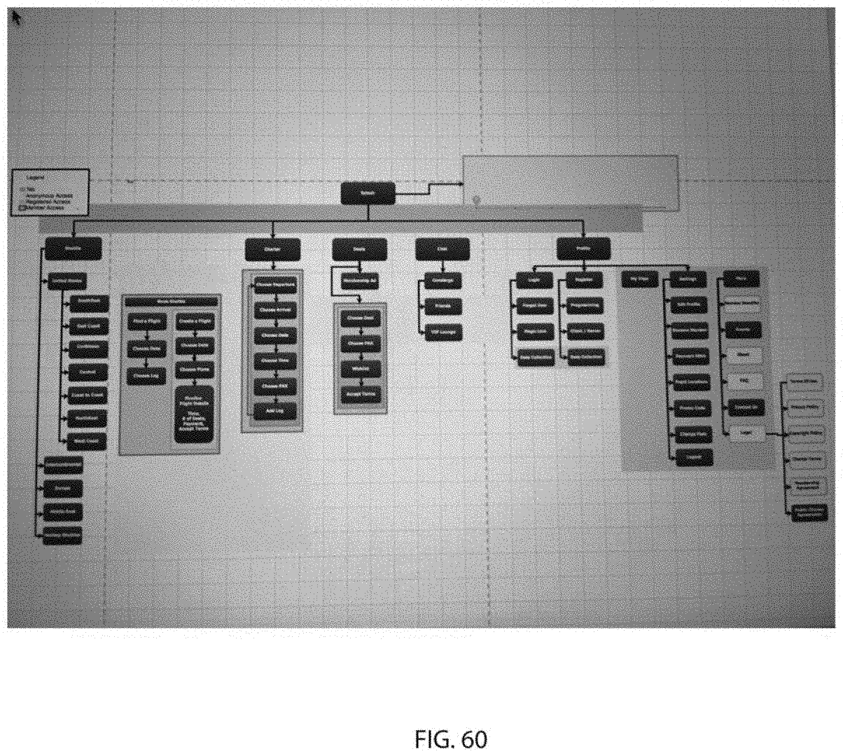

FIG. 60 is a site map of the server-side flow for FIGS. 1-59. In the example, FIGS. 7-26 represents screen shots of the profile screens.

It is understood that there is an option to filter the information in their own individual data record to be available to just ‘friends of friends’ or ‘friends of friends of friends’, i.e. individuals of second or third order of contact separation from the user.

This key feature of the present invention enables a user to apply selective control over the type of interaction with other system users depending on their degree of separation from the user.

It will be apparent to one skilled in the art that many variants of the described embodiment are possible without departing from the scope of the invention.

In an alternative embodiment (not shown), any of the users may input a variety of supplementary personal attributes/information as part of the identifying characteristics including their including marital or relationship status, hobbies, interests, favorite destinations, and more.

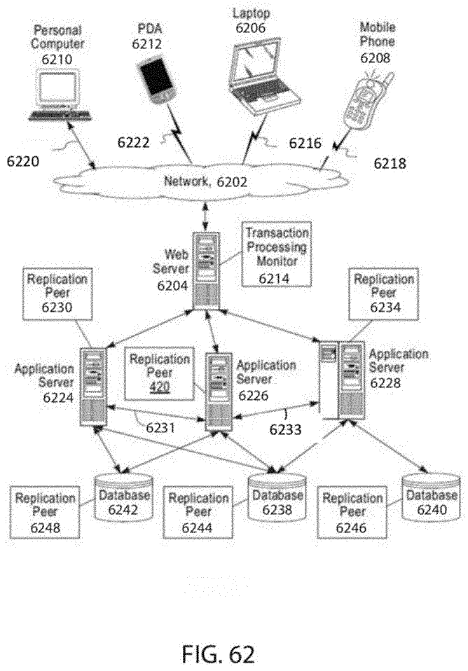

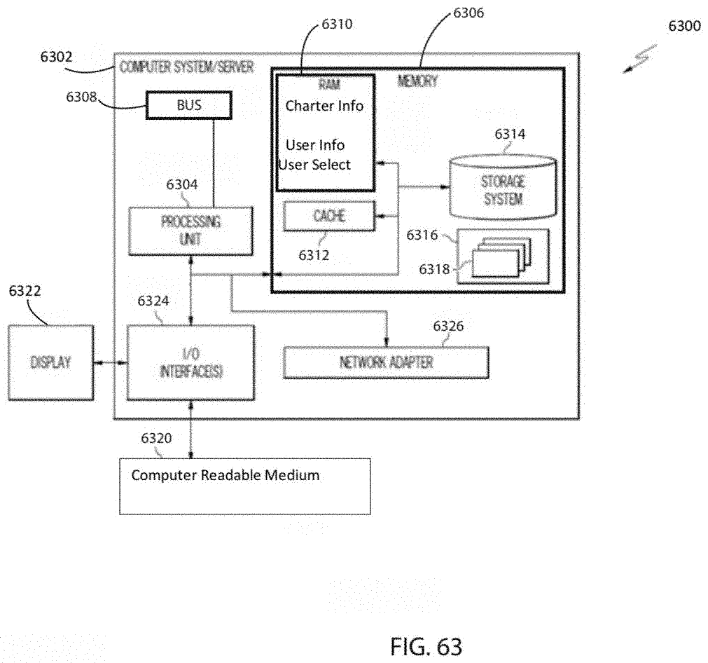

Furthermore, close friends (i.e. first order connections or direct contacts), as opposed to friends of friends (second or third order connections), may be offered a means of recording a rating, assessment, quantification, qualification, or comment regarding the details stored in the relevant individual data record in databases or storage of FIGS. 62 and 63. This can provide a means of limiting any excessive boasting/hyperbole or reticence/down-playing by an individual and thus provide a more accurate description.

It should be understood that the system does not specifically require the user entities to contact each other via the Internet, rather, it provides the information required (e.g. a common friend) to contact an individual with whom the inquirer is known to share a common link.

Even though many user entities may find e-mail to be a convenient means of contact, there is nothing precluding the use of the telephone, letter writing, personal contact, or any of the ‘conventional’ means already available to the public. Such contact details may simply be recorded as part of the data records and made searchable to prescribed users.

The invention possesses several security features not shared by existing social media sites. Firstly, only individuals sharing a common link (e.g. friendship) are able to obtain access to another individual's personal details, i.e. their data record. No information is disclosed to the ‘outside world’. This greatly reduces the concern and likelihood of approaches from ‘crank individuals’, whether perceived or actual.

Secondly, the system does not rely on the user entities inputting large amounts of personal and potentially private information into a database over which they have no access control. Many users may feel less threatened by recording the minimal information needed on the database, particularly with the reassurance that the information is only viewable by first, second, or third order connections.

The present invention manages all the aspects of pricing an aircraft. This is very different then just being a broker of charters. The present invention eliminates the need for a separate broker or intermediary. These costs include the cost of fuel, the cost of aircraft, cost of pilot and crew, landing fees, repositioning fees (if any), and maintenance of aircraft that are owned.

FIG. 61 illustrates a social network displayed with a user's first, second, third, and fourth order connections highlighted. More specifically, shown is a graphical representation of the networks referred to herein whereby the relationships between individual entities 6154 are illustrated by interconnecting links 6155. It will be apparent that each individual has their own unique private network which differs even from those to whom they are connected. FIG. 61 also shows the different networks associated with each individual when the connections include first, second, third, and fourth order connections, as illustrated by the concentric circles enclosing first, second, and third order connections 6156, 6157, 6158, respectively.

### Operating Environment:

FIG. 62 is the n-tier architecture upon which flow diagrams of FIGS. 59-60 can operate. It should be noted that although the following discussion is directed to a cloud computing environment, various embodiments are not limited to such environment and are applicable to non-cloud computing environments as well.

It is important to note that although only a 3-tier architecture is shown, those of average skill in the computing arts will appreciate that this architecture can be easily extended to four or more tiers as in a multi-tier or n-tier system.

Referring to FIG. 62, shown is a multi-tier system architecture with a tier of clients 6210, 6212, 6206, 6208, a tier of application servers 6224, 6226, 6228, and a tier of non-volatile storage in databases 6238, 6240, 6242. This multi-tier client/server architecture improves performance and flexibility for systems with a large number of users. Flexibility in partitioning can be as simple as “dragging and dropping” application code modules onto different computers in some multi-tier architectures.

This multi-tiered system has evolved from a more conventional system architecture in which clients retrieve information from a database, process the data according to instructions from a user, and store the data in the database. The clients in the conventional system architecture have three types of computer instructions installed and running on them to process information: code for the user interface (displaying buttons and lists of data); code for interacting with the database to fetch or store data; and code that processes the fetched data according to commands from the user interface or business logic. In contrast, in the multi-tiered system architecture, the client may contain only user interface code. The code for interacting with the database and processing the data is installed and operates on a middle-tier of servers such as application servers of FIG. 62. The middle tier of servers interacts with the database and processes data on behalf of the client. The multi-tiered system of architecture therefore has the advantage of forcing separation of user interface and business logic, requiring a low bandwidth for the network, and requires the concentration of business logic code in only a few machines, rather than inserting business logic into all application software on all clients.

There are a variety of ways of implementing this middle tier, such as transaction processing monitors, message servers, or application servers. The middle tier can perform queuing, application execution, and database staging. For example, if the middle tier provides queuing, the client can deliver its request to the middle layer and disengage because the middle tier will access the data and return the answer to the client. In addition, the middle tier adds scheduling and prioritization for work in progress.

The exemplary web server 6204 of FIG. 62 also has a transaction processing monitor (TPM) 6214 installed and operating on it. The TPM technology is a type of message queuing, transaction scheduling, and prioritization service where the client connects to the TPM (middle tier) instead of the database server. The transaction is accepted by the monitor, which queues it and then takes responsibility for managing it to completion, thus freeing up the client. The TPM 6214 provides applications' services to many clients by multiplexing client transaction requests onto a controlled number of processing routines that support particular services.

As noted above, the system of FIG. 62 includes several exemplary clients 6210, 6212, 6206, 6208. A client is a computer, process, or thread running on a computer that requests resources or services from another computer. Exemplary clients of FIG. 62 include: a personal computer 6210 coupled to the network 6202 through a wireline connection 6220, a personal digital assistant (PDA) 6222 coupled to the network 6202 through a wireless connection 6222, a laptop computer 6206 coupled to the network 6202 through a wireless connection 6216, and a mobile telephone 6208 which is coupled to the network 6202 through a wireless connection 6218.

The system of FIG. 62 includes a data communications network 6202 which provides for data communications among clients 6210, 6212, 6206, 6208 and a web server 6204. A network is a group of computers coupled for data communications according to data communications protocols through other computers typically referred to as routers, bridges, or switches (not shown).

The web server 6204 is a computer, a process, or a thread running on a computer that receives, processes, and responds to requests for resources or services from another computer. A web server is a server that carries out data communication according to a hyperlinking protocol. A common example of a hyperlinking protocol is the Hypertext Transfer Protocol, the foundation of the World Wide Web. The term “web server” is used in this specification more broadly, however, to refer to any server that support any hyperlinking protocol, including, for example, the Wireless Access Protocol (WAP), the Handheld Device Transport Protocol (HDTP), and others as will occur to those of skill in the art. The web server 6204 provides static web pages in response to clients as well as dynamic web pages in such formats as Java Server Pages (JSP), PHP Hypertext Processor (PHP) pages, Microsoft's Active Server Pages (ASP), and Common Gateway Interface (CGI) scripts, and others as will occur to those of skill in the art.

Some caution is advised in use of the terms “client” and “server” because whether a particular computer acts as a client or a server depends upon role. In the system of FIG. 62, for example, when web server 6214 receives from personal computer 6210 a request for a web page, web server 6204 is acting as a server. When, however, web server 6204 requests resources from application server 6224 in order to fulfill the request from personal computer 6210, web server 6204 acts as a client.

The system of FIG. 62 also includes application servers 6224, 6226, 6228 coupled to web server 6204 to provide data communications. The application servers 6224, 6226, 6228 are also connected to databases 6238, 6240, 6242 and to each other 6231, 6233. The system of FIG. 62 also includes non-volatile storage in the form of databases 6238, 6240, 6242. The application servers 6224, 6226, 6228 and the databases 6238, 6240, 6242 have replication peers 6230, 6234, 6244, 6246, 6248 installed and operating on them. A peer is a computer or a process or thread running on a computer that has the same capabilities of requesting and responding to requests as other computers in a similarly situated network. A replication peer is a software module that stores on a replication medium sessions flushed from a replication queue. A replication peers 6244, 6246, 6248 may store a session from an application server 6224, 6226, 6228 onto non-volatile storage in a database 6238, 6240, 6242. Replication peers 6230, 6234 may also store 6231, 6233 a session from an application server 6224, 6226, 6228 onto remote random-access memory on another application server.

The arrangement of servers and other devices making up the exemplary system illustrated in FIG. 62 are for explanation and not intended to be limiting. Data processing systems according to various embodiments of the present invention may include additional servers, routers, other devices, and peer-to-peer architectures, not shown in FIG. 62, as will occur to those of skill in the art. Networks in such data processing systems may be implemented as local area networks (LANs), wide area networks (WANs), intranets, internets, and others as will occur to those of skill in the art. Networks in such data processing systems may support many data communications protocols, including, for example, the Transmission Control Protocol (TCP), the Internet Protocol (IP), the Hypertext Transfer Protocol (HTTP), the Wireless Access Protocol (WAP), the Handheld Device Transport Protocol (HDTP), and others as will occur to those of skill in the art. Various embodiments of the present invention may be implemented on a variety of hardware platforms in addition to those illustrated in FIG. 62.

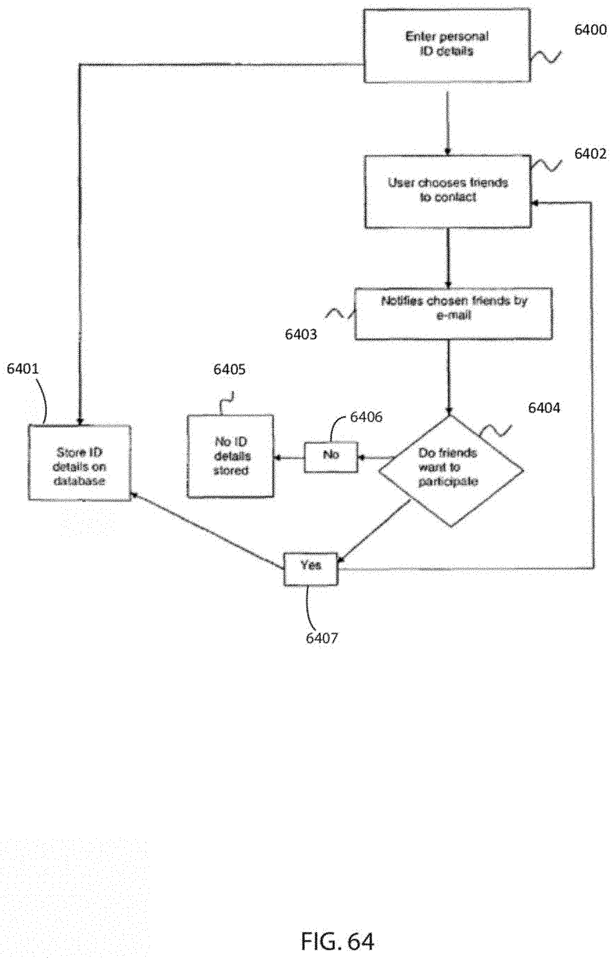

Use of FIG. 64 for a private social network achieving the processes illustrated FIG. 62 and FIG. 63 is now described. FIG. 64 shows a schematic block diagram of a system for providing connections between entities, implemented on a computer system according to the present invention.

The term “entity” or “entities” includes any individual, family, organization, club, society, company, partnership, religion, or the like that exists as a particular and discrete unit. However, though for the sake of clarity and convenience the term “individual” or “user entity” (as appropriate) is used in the following examples, this does not restrict the present invention to same.

The computer system includes a host computer in the form of an Internet web server, containing a processor connectable to a network, in particular the internet, a database accessible over said network and a plurality of data input devices, represented by user entity computers.

It will be appreciated that by those skilled in the art that the invention is not necessarily limited to use with the internet and that a connection to the host computer/web server may be provided by a propriety network enabling access by via text-messaging telephones for example.

The present invention provides a system providing one or more user entities with a unique, private personal social network formed from connections between contacts or entities connected directly or indirectly to the user.

Thus, the present invention is particularly suited to implementation in a variety of implementations to facilitate the introduction of individuals from a user's unique, personal private network. In the system, the users would be drawn from friends or friends of friends, or even optionally friends of friend of friends and so forth.

After entering the user's identifying characteristic at step 6400, the user selects one or more chosen individuals from their network of friends in step 6402. Each said chosen friend is then notified by an e-mail at step 6403. The e-mail notification effected in step 6403, conveys to the recipient a brief outline of the service together with a request for their participation at step 6404).

No individual data records are recorded/stored at step 6405for recipients choosing not to participate (step 6406) or simply wishing to help their friends without their own details being accessible to others. Individuals willing to participate (step 6407) are invited to enter details of their own friends in a repetition of step 6406. The details of the chosen friends entered, i.e., the identifying characteristic in this embodiment are the friend's e-mail address and name which is stored in a database at step 6401. The individuals chosen for contact are notified by e-mail in a repetition of step 6403.

The whole process as described above of notifying friends, recording the details of willing participants as individual user data records, and contacting the chosen friend's friends and so forth is successively repeated in this manner until the full extended network of friends has been contacted.

### Example Computer System:

FIG. 63 is an example hardware implementation of the client and/or cloud computer upon which flow diagrams of FIG. 59 can operate. FIG. 63 illustrates one example of a processing node and is not intended to suggest any limitation as to the scope of use or functionality of embodiments of the invention described herein. Regardless, the computing node 6300 is capable of being implemented and/or performing any of the functionality set forth hereinabove.

In computing node 6300, there is a computer system/server 6302, which is operational with numerous other general purpose or special purpose computing system environments or configurations. Examples of well-known computing systems, environments, and/or configurations that may be suitable for use with computer system/server 6302 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 6302 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 6302 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 63, computer system/server 6302 in cloud computing node 6300 is shown in the form of a general-purpose computing device. The components of computer system/server 6302 may include, but are not limited to, one or more processors or processing units 6304, a system memory 6306, and a bus 6308 that couples various system components including system memory 6306 to processor 6304.

Bus 6308 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 6302 typically includes a variety of computer system readable media. Such media may be any available media that is accessible by computer system/server 6302, and it includes both volatile and non-volatile media, removable and non-removable media.

System memory 6306, in one embodiment, implements the block diagram of FIG. 62 and the flow charts of FIG. 59. The system memory 6306 can include computer system readable media in the form of volatile memory, such as random access memory (RAM) 6310 and/or cache memory 6312. Computer system/server 6302 may further include other removable/non-removable, volatile/non-volatile computer system storage media. By way of example only, storage system 6314 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 6308 by one or more data media interfaces. As will be further depicted and described below, memory 6306 may include at least one program product having a set (e.g., at least one) of program modules that are configured to carry out the functions of various embodiments of the invention.

Program/utility 6316, having a set (at least one) of program modules 6318, may be stored in memory 6306 by way of example, and not limitation, as well as an operating system, one or more application programs, other program modules, and program data. Each of the operating system, one or more application programs, other program modules, and program data or some combination thereof, may include an implementation of a networking environment. Program modules 6318 generally carry out the functions and/or methodologies of various embodiments of the invention as described herein.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. The computer program product is typically non-transitory but in other examples it may be transitory.

Computer system/server 6302 may also communicate with one or more external devices 6320 such as a keyboard, a pointing device, a display 6322, etc.; one or more devices that enable a user to interact with computer system/server 6302; and/or any devices (e.g., network card, modem, etc.) that enable computer system/server 6302 to communicate with one or more other computing devices. Such communication can occur via I/O interfaces 6324. Still yet, computer system/server 6302 can communicate with one or more networks such as a local area network (LAN), a general wide area network (WAN), and/or a public network (e.g., the Internet) via network adapter 6326. As depicted, network adapter 6326 communicates with the other components of computer system/server 6302 via bus 6308. It should be understood that although not shown, other hardware and/or software components could be used in conjunction with computer system/server 6302. Examples, include, but are not limited to: microcode, device drivers, redundant processing units, external disk drive arrays, RAID systems, tape drives, and data archival storage systems, etc.

### Non-Limiting Examples:

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

One skilled in the art will readily recognize from such discussion, and from the accompanying drawings and claims, that various changes, modifications, and other variations can be made therein without departing from the full scope of the disclosed inventive concept as defined by the following claims.

What is claimed is:

1. A computer-implemented method on a server computer for charter airline reservations, the method comprising:
accessing a storage media commutatively coupled to a server computer as part of a charter reservation system;
receiving user input including a minimum number of seats, destination, and date range for reserving one or more seats on a charter airline for a specified route and time, in which the user is financially responsible for all the available seats on the charter airline;
sending the user input to a plurality of private charter airlines without the use on an intermediate broker;
sending offers received from private charter airlines to the user;
receiving user input regarding one of the offers received to reserve a customized charter shuttle with routes and times prescribed by the user input (“Astro Charter”), in which this customized charter shuttle does not regularly offer these routes and times;
receiving user input offer any available seats left on the reserve shuttle to a group of registered users on the charter reservation system;
sending notices to other registered users on the charter system;
for each available seat sold to other registered users on the customized charter, providing credit to the user.

2. The computer-implemented method of claim 1, in which the group of registered users on the charter reservation system is at least one of family, work, friends, or a combination thereof.

3. The computer-implemented method of claim 1, further comprising:
upon a time period expiring, sending to a larger group of registered users regarding the available seats.

4. The computer-implemented method of claim 1, in which the group of registered users on the charter reservation system is within a predetermined geolocation of the origination city for the route of the customized charter.

5. The computer-implemented method of claim 4, wherein the geolocation of the origination city for the route of the customized charter.

6. A system for charter airline reservations, the system comprising:
a computer memory capable of storing machine instructions; and
a hardware processor in communication with the computer memory, the hardware processor configured to access the computer memory, the hardware processor performing:
accessing a storage media commutatively coupled to a server computer as part of a charter reservation system;
receiving user input including a minimum number of seats, destination, and date range for reserving one or more seats on a charter airline for a specified route and time, in which the user is financially responsible for all the available seats on the charter airline;
sending the user input to a plurality of private charter airlines without the use on an intermediate broker;
sending offers received from private charter airlines to the user;
receiving user input regarding one of the offers received to reserve a customized charter shuttle with routes and times prescribed by the user input (“Astro Charter”), in which this customized charter shuttle does not regularly offer these routes and times;
receiving user input offer any available seats left on the reserve shuttle to a group of registered users on the charter reservation system;
sending notices to other registered users on the charter system;
for each available seat sold to other registered users on the customized charter, providing credit to the user.

7. The system of claim 6, in which the group of registered users on the charter reservation system is at least one of family, work, friends, or a combination thereof.

8. The system of claim 6, further comprising:
upon a time period expiring, sending to a larger group of registered users regarding the available seats.

9. The system of claim 6, in which the group of registered users on the charter reservation system is within a predetermined geolocation of the origination city for the route of the customized charter.

10. The system of claim 9, wherein the geolocation of the origination city for the route of the customized charter.

11. A non-transitory computer program product tangibly embodying computer readable instructions which, when implemented, cause a computer to carry out the steps for a charter airline reservations, comprising:
accessing a storage media commutatively coupled to a server computer as part of a charter reservation system;
receiving user input including a minimum number of seats, destination, and date range for reserving one or more seats on a charter airline for a specified route and time, in which the user is financially responsible for all the available seats on the charter airline;
sending the user input to a plurality of private charter airlines without the use on an intermediate broker;
sending offers received from private charter airlines to the user;
receiving user input regarding one of the offers received to reserve a customized charter shuttle with routes and times prescribed by the user input (“Astro Charter”), in which this customized charter shuttle does not regularly offer these routes and times;
receiving user input offer any available seats left on the reserve shuttle to a group of registered users on the charter reservation system;
sending notices to other registered users on the charter system;
for each available seat sold to other registered users on the customized charter, providing credit to the user.

12. The non-transitory computer program product of claim 11, in which the group of registered users on the charter reservation system is at least one of family, work, friends, or a combination thereof.

13. The non-transitory computer program product of claim 11, further comprising:
upon a time period expiring, sending to a larger group of registered users regarding the available seats.

14. The non-transitory computer program product of claim 11, in which the group of registered users on the charter reservation system is within a predetermined geolocation of the origination city for the route of the customized charter.

15. The non-transitory computer program product of claim 14, wherein the geolocation of the origination city for the route of the customized charter.
